(19) United States
(12) Patent Application Publication
(10) Pub. No.: US 2026/0048744 A1
(43) Pub. Date: Feb. 19, 2026

(54) CONTROL DEVICE, CONTROL METHOD, AND STORAGE MEDIUM

(71) Applicant: HONDA MOTOR CO., LTD., Tokyo (JP)

(72) Inventors: Hironori HIRATA, Tokyo (JP); Takahiro OSAWA, Tokyo (JP); Yoshihiro KATSUYAMA, Tokyo (JP)

(73) Assignee: HONDA MOTOR CO., LTD., Tokyo (JP)

(21) Appl. No.: 19/250,121

(22) Filed: Jun. 26, 2025

(30) Foreign Application Priority Data
Jun. 28, 2024 (JP) 2024-104996

(51) Int. Cl. B60W 30/18; G01C 21/30

(52) U.S. Cl. CPC B60W 30/18009; G01C 21/30; B60W 2520/10; B60W 2556/40

(57) ABSTRACT

A vehicle control device includes: a processor configured to perform travel control for moving a vehicle to a target position and to transition between a first and a second travel mode, the vehicle including an external environment recognition unit and a storage unit configured to store map information on a region including a predetermined determination area and a travelable area where traveling in the second travel mode is possible. The processor determines, in response to the vehicle entering the determination area while the vehicle is traveling in the first travel mode, a travel condition in the second travel mode, the travel condition including whether external environment information and the map information satisfy a predetermined matching condition, transition, in response to determining that the travel condition is satisfied and the vehicle enters the travelable area, to the second travel mode, and cause the vehicle to travel in the second travel mode.

### TECHNICAL FIELD

The present disclosure relates to a control device, a control method, and a storage medium storing a control program.

### BACKGROUND ART

In recent years, active efforts have been made to provide access to a sustainable transportation system in consideration of vulnerable people among traffic participants. In order to implement the above, focus has been placed on research and development on further improving safety and convenience of traffic by research and development related to autonomous driving technology.

In the related art, in an autonomous driving system that causes a vehicle to travel autonomously without requiring a driving operation of a user, it is known that a route taken when a vehicle travels to a target position by a driving operation of a user is stored, and when the vehicle travels toward the same target position or on the same route, the vehicle is caused to travel based on a stored route history. In addition, it is known that route information on a route from a current position to the target position is generated based on information acquired by an in-vehicle sensor to cause the vehicle to travel.

For example, JP2023-63070A discloses a vehicle travel assist device that, in a case where it is determined that a vehicle will enter an intrusion prohibited area when moving along a target route, provides assist in correcting the target route in a stored route history so that the vehicle does not enter the intrusion prohibited area, and provides assist in moving the vehicle to a target stop position along the corrected target route and stopping the vehicle at the target stop position.

### SUMMARY OF INVENTION

In a case where a vehicle is assisted to be driven to a target position, for example, there may be general travel assistance of the vehicle performed when traveling on a general road, and specific region travel assistance in which travel assistance of the vehicle is performed using a user travel route when traveling to the target position by a driving operation of a user. In this case, for example, when the vehicle travels from a general road to a specific region, smooth switching of a travel mode from the general travel assistance to the specific region travel assistance is desired. However, Patent Literature 1 does not disclose the switching of the travel mode from the general travel assistance to the specific region travel assistance.

An object of the present invention is to provide a vehicle control device, a vehicle control method, and a control program that are capable of smoothly transitioning a travel mode.

According to an aspect of the present disclosure, there is provided a vehicle control device including:
at least one processor configured to perform travel control for moving a vehicle to a target position and to transition between a first travel mode and a second travel mode, the vehicle including an external environment recognition unit configured to perform external environment recognition; and
   a storage unit configured to store map information, in which
   the map information is map information on a region including a predetermined determination area and a travelable area where traveling in the second travel mode is possible, and
      the at least one processor is configured to
         determine, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition,
         transition, in response to determining that the travel condition is satisfied and the vehicle enters the travelable area, to the second travel mode, and
         cause the vehicle to travel in the second travel mode based on the map information stored in the storage unit and the external environment information obtained by the external environment recognition unit.

According to another aspect of the present disclosure, there is provided a vehicle control method performed by a vehicle control device, the vehicle control device including at least one processor configured to perform travel control for moving a vehicle to a target position and to transition between a first travel mode and a second travel mode, the vehicle including an external environment recognition unit configured to perform external environment recognition and a storage unit configured to store map information that is map information on a region including a predetermined determination area and a travelable area where traveling in the second travel mode is possible, the vehicle control method including:
determining, by the at least one processor, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition;
transitioning, by the at least one processor, to the second travel mode in response to determining that the travel condition is satisfied and the vehicle enters the travelable area; and
causing, by the at least one processor, the vehicle to travel in the second travel mode based on the map information stored in the storage unit and the external environment information obtained by the external environment recognition unit.

According to another aspect of the present disclosure, there is provided a non-transitory computer-readable storage medium storing a control program for a vehicle control device, the vehicle control device including at least one processor configured to perform travel control for moving a vehicle to a target position and to transition between a first travel mode and a second travel mode, the vehicle including an external environment recognition unit configured to perform external environment recognition and a storage unit configured to store map information that is map information on a region including a predetermined determination area and a travelable area where traveling in the second travel mode is possible, the control program causing the at least one processor to execute processing including:
determining, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition;
transitioning to the second travel mode in response to determining that the travel condition is satisfied and the vehicle enters the travelable area; and
causing the vehicle to travel in the second travel mode based on the map information stored in the storage unit and the external environment information obtained by the external environment recognition unit.

According to the present invention, it is possible to provide a vehicle control device, a vehicle control method, and a control program that are capable of smoothly transitioning a travel mode.

### BRIEF DESCRIPTION OF DRAWINGS

Exemplary embodiment(s) of the present invention will be described in detail based on the following figures, wherein:

FIG. 1 is a block diagram illustrating a configuration of a vehicle 1 equipped with a control device 100 according to an embodiment;

FIG. 2 is a sequence diagram (part 1) illustrating a first operation example of the vehicle 1;

FIG. 3 is a sequence diagram (part 2) illustrating the first operation example of the vehicle 1;

FIG. 4 is a diagram illustrating an initial example of a state in which the vehicle 1 on which a user gets is traveling with a parking lot 170 at home as a target position;

FIG. 5 is a sequence diagram (part 1) illustrating a second operation example of the vehicle 1;

FIG. 6 is a sequence diagram (part 2) illustrating the second operation example of the vehicle 1;

FIG. 7 is a diagram illustrating a next example of the state in which the vehicle 1 on which the user gets is traveling with the parking lot 170 at home as the target position;

FIG. 8 is a sequence diagram (part 1) illustrating a third operation example of the vehicle 1;

FIG. 9 is a sequence diagram (part 2) illustrating the third operation example of the vehicle 1;

FIG. 10 is a diagram illustrating an initial example of a state in which the vehicle 1 on which the user gets travels with the parking lot 170 at home as an operation start position;

FIG. 11 is a sequence diagram (part 1) illustrating a fourth operation example of the vehicle 1;

FIG. 12 is a sequence diagram (part 2) illustrating the fourth operation example of the vehicle 1;

FIG. 13 is a diagram illustrating a next example of the state in which the vehicle 1 on which the user gets travels with the parking lot 170 at home as the operation start position;

FIG. 14 is a diagram illustrating a state in which the user gets on the vehicle 1 and starts an engine at a destination;

FIG. 15 is a diagram illustrating a state in which the vehicle 1 is traveling on a general road 210 by general road assistance control;

FIG. 16 is a diagram illustrating the start of private land section memory of the vehicle 1:

FIG. 17 is a diagram illustrating a state in which the vehicle 1 reaches a home 200, which is the target position;

FIG. 18 is a diagram illustrating a state of the vehicle 1 returning to the home 200 along a travel route D different from a travel route C in FIG. 17; and

FIG. 19 is a diagram illustrating a state of the vehicle 1 returning to the home 200 along the same travel route as the travel route C in FIG. 17.

### DESCRIPTION OF EMBODIMENTS

Hereinafter, an embodiment of a vehicle control device, a vehicle control method, and a storage medium storing a control program of the present disclosure will be described with reference to the accompanying drawings.

### Vehicle 1 Equipped With Control Device 100 according to Embodiment

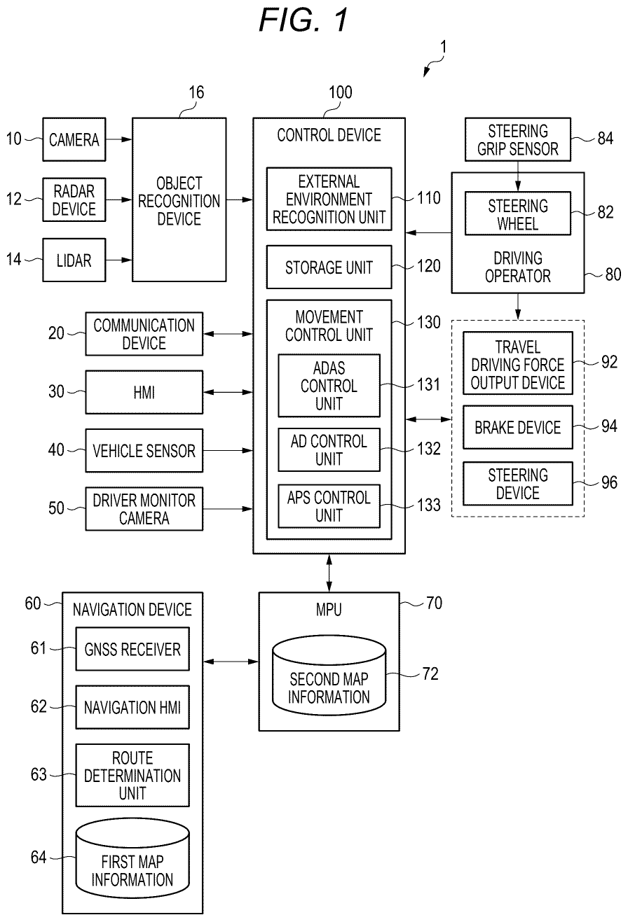

FIG. 1 is a block diagram illustrating a configuration of a vehicle 1 equipped with a control device 100 according to an embodiment. The control device 100 is an example of a “vehicle control device” in the present disclosure. The vehicle 1 is a vehicle that can execute so-called autonomous driving or assisted driving. The vehicle 1 is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by an electric generator connected to the internal combustion engine or electric power discharged from a secondary battery or a fuel cell.

The vehicle 1 includes a camera 10, a radar device 12, a light detection and ranging (LIDAR) 14, an object recognition device 16, a communication device 20, a human machine interface (HMI) 30, a vehicle sensor 40, a driver monitor camera 50, a navigation device 60, a map positioning unit (MPU) 70, a driving operator 80, the control device 100, a travel driving force output device 92, a brake device 94, and a steering device 96. These devices and equipment are connected to each other via, for example, a multiplex communication line such as a controller area network (CAN) communication line, a serial communication line, or a wireless communication network.

The camera 10 is, for example, a digital camera using a solid-state imaging device such as a charge coupled device (CCD) or a complementary metal oxide semiconductor (CMOS). The camera 10 is attached at any position on the vehicle 1.

The radar device 12 emits radio waves such as millimeter waves around the vehicle 1, and detects radio waves (reflected waves) reflected by an object to detect at least a position (distance and orientation) of the object. The radar device 12 is attached at any position on the vehicle 1.

The LIDAR 14 emits light (or an electromagnetic wave having a wavelength close to that of light) around the vehicle 1 and measures scattered light. The LIDAR 14 detects a distance to a target based on a time elapsed from light emission to light reception. The emitted light is, for example, pulsed laser light. The LIDAR 14 is attached at any position on the vehicle 1.

The object recognition device 16 executes sensor fusion processing on some or all of detection results of the camera 10, the radar device 12, and the LIDAR 14 to recognize a position, a type, a speed, and the like of an object. The object recognition device 16 outputs a recognition result to the control device 100. The object recognition device 16 may output the detection results of the camera 10, the radar device 12, and the LIDAR 14 to the control device 100 as they are.

The communication device 20 uses, for example, a cellular network, a Wi-Fi (registered trademark) network, Bluetooth (registered trademark), or dedicated short range communication (DSRC) to communicate with other vehicles present in the surroundings of the vehicle 1 or communicate with various server devices via a radio base station.

The HMI 30 presents various types of information to an occupant of the vehicle 1 and receives an input operation from the occupant. The HMI 30 includes various types of display devices, a speaker, a buzzer, a touch panel, a switch, a key, and the like.

The vehicle sensor 40 includes a vehicle speed sensor that detects a speed of the vehicle 1, an acceleration sensor that detects an acceleration, a yaw rate sensor that detects an angular velocity around a vertical axis, an azimuth sensor that detects an orientation of the vehicle 1, and the like.

The driver monitor camera 50 is, for example, a digital camera using a solid-state imaging device such as a CCD or a CMOS. The driver monitor camera 50 is attached at any position on the vehicle 1 in a position and an orientation in which a head of an occupant (hereinafter, also referred to as a “driver”) seated in a driver's seat of the vehicle 1 is able to be imaged from the front (that is, in an orientation in which a face is imaged).

The navigation device 60 includes, for example, a global navigation satellite system (GNSS) receiver 61, a navigation HMI 62, and a route determination unit 63. The navigation device 60 stores first map information 64 in a storage device such as a hard disk drive (HDD) or a flash memory.

The GNSS receiver 61 specifies a position of the vehicle 1 based on a signal received from a GNSS satellite. The position of the vehicle 1 may be specified or complemented by an inertial navigation system (INS) using an output of the vehicle sensor 40.

The navigation HMI 62 includes a display device, a speaker, a touch panel, a key, and the like. The navigation HMI 62 may be made common to the HMI 30 partially or entirely.

For example, with reference to the first map information 64, the route determination unit 63 determines a route (hereinafter, also referred to as an “on-map route”) from the position of the vehicle 1 specified by the GNSS receiver 61 (or any position that is received) to a destination input by the occupant using the navigation HMI 62. The first map information 64 is, for example, information in which a road shape is expressed by a link indicating a road and nodes connected by the link. The first map information 64 may include a curvature of a road, point of interest (POI) information, and the like. The on-map route is output to the MPU 70.

The navigation device 60 may perform route guidance using the navigation HMI 62 based on the on-map route. The navigation device 60 may transmit a current position and the destination to a navigation server via the communication device 20 and acquire a route equivalent to the on-map route from the navigation server.

The MPU 70 stores second map information 72 in a storage device such as an HDD or a flash memory. The second map information 72 is map information with higher accuracy than the first map information 64. The second map information 72 includes, for example, information on a center of a lane or information on a boundary of the lane. The second map information 72 may include road information, traffic regulation information, address information, facility information, telephone number information, and the like. The second map information 72 may be updated, as required, by the communication device 20 communicating with another device.

The driving operator 80 includes, for example, an accelerator pedal, a brake pedal, a shift lever, and other operators in addition to a steering wheel 82 (an example of a steering device). A sensor that detects an operation amount or presence or absence of an operation is attached to the driving operator 80, and a detection result thereof is output to some or all of the control device 100, the travel driving force output device 92, the brake device 94, and the steering device 96. The steering wheel 82 is not necessarily in an annular shape, and may be in a form of irregular steering, joy stick, a button, or the like.

A steering grip sensor 84 is attached to the steering wheel 82. The steering grip sensor 84 is implemented by a capacitance sensor or the like, and outputs, to the control device 100, a signal capable of detecting whether the driver is gripping the steering wheel 82.

The control device 100 includes an external environment recognition unit 110, a storage unit 120, and a movement control unit 130.

The external environment recognition unit 110 acquires, from the object recognition device 16, external environment information for recognizing an external environment of the vehicle 1 that is acquired by the camera 10, the radar device 12, and the LIDAR 14. The external environment recognition unit 110 performs external environment recognition based on the acquired external environment information (spatial information).

The storage unit 120 stores a program for the movement control unit 130 to control each unit. The storage unit 120 stores map information based on the external environment information obtained by the external environment recognition unit 110. The storage unit 120 stores map information based on external environment information obtained by the external environment recognition unit 110 during past traveling of the vehicle 1. The storage unit 120 stores a route during the past traveling of the vehicle 1 and the map information based on the external environment information obtained by the external environment recognition unit 110 during the past traveling in association with each other.

The movement control unit 130 performs travel control for moving the vehicle 1 to a target position. The movement control unit 130 includes an ADAS control unit 131, an AD control unit 132, and an APS control unit 133. The ADAS control unit 131 is implemented by an advanced driver assistance systems electronic control unit (ADAS_ECU). The AD control unit 132 is implemented by an automatic driving electronic control unit (AD_ECU). Similarly to the AD control unit 132, the APS control unit 133 is implemented by an AD_ECU. However, the APS control unit 133 may be implemented by, for example, an automatic parking systems electronic control unit (APS_ECU), which is a separate circuit from the AD control unit 132. The movement control unit 130 (the ADAS control unit 131, the AD control unit 132, and the APS control unit 133) is an example of at least one “processor”in the present disclosure.

Each of the ADAS_ECU, the AD_ECU, and the APS_ECU is implemented by, for example, a hardware processor such as a central processing unit (CPU) executing a program (software). Some or all of these components may be implemented by hardware (including circuitry) such as a large scale integration (LSI), an application specific integrated circuit (ASIC), a field-programmable gate array (FPGA), and a graphics processing unit (GPU), or may be implemented by cooperation of software and hardware. The program may be stored in advance in a storage device such as an HDD or a flash memory of the control device 100.

The movement control unit 130 can perform travel control of the vehicle 1 by general road assistance control and travel control of the vehicle 1 by private land section control. The general road assistance control is, for example, a travel mode of assisted driving applied to traveling of the vehicle 1 on a general road and a highway. The private land section control is, for example, a travel mode of the assisted driving applied to the traveling of the vehicle 1 in a private land section from a general road to an inside of a parking lot of a private land, for example, in a private land (including a private road) in the United States or the like. The general road assistance control is an example of a “first travel mode” in the present disclosure. The private land section control is an example of a “second travel mode”in the present disclosure.

When the vehicle 1 enters a predetermined determination area for determining a travel condition of the vehicle 1 during traveling of the vehicle 1 by the travel control of the general road assistance, the movement control unit 130 determines a travel condition for performing the travel control of the vehicle 1 by the private land section control. When it is determined that the travel condition is satisfied, the movement control unit 130 performs a first notification for prompting a user to perform a transition approval operation for transitioning the travel control of the vehicle 1 from the general road assistance control to the private land section control. When an approval operation of the user in response to the first notification is received, the movement control unit 130 transitions the travel control of the vehicle 1 from the general road assistance control to the private land section control. The “determination area” is, for example, an area where a remaining distance on a travel route of the vehicle 1 to a target position is equal to or less than a preset distance (for example, a remaining distance is equal to or less than 88 m).

When the vehicle 1 enters the determination area during the traveling of the vehicle 1 by the general road assistance control, the movement control unit 130 performs deceleration control of the vehicle 1 for determining the travel condition, and performs a second notification to the user regarding the deceleration control. When the vehicle 1 enters the determination area during the traveling of the vehicle 1 by the general road assistance control, the movement control unit 130 may perform a third notification for prompting the user to perform the deceleration control of the vehicle 1 for determining the travel condition. That is, the movement control unit 130 may decelerate the vehicle 1 by, for example, a brake operation of the user instead of decelerating the vehicle 1 by the control of the control unit.

The travel condition in the private land section control is, for example, that the travel route of the vehicle 1 to the target position includes a region in which traveling is possible by the private land section control. Whether the “region in which traveling is possible by the private land section control” is included is determined by, for example, whether map information having a matching feature is stored in the storage unit 120. Alternatively, the determination may be made based on whether the map information stored in the storage unit 120 is associated with an area (represented by latitude and longitude or the like) and whether the associated area is included in the “route to the target position”.

In the private land section control, the movement control unit 130 causes the vehicle 1 to travel based on the map information stored in the storage unit 120 and the external environment information obtained by the external environment recognition unit 110. The travel condition in the private land section control at this time is, for example, that the external environment information obtained by the external environment recognition unit 110 in the determination area and the map information stored in the storage unit 120 satisfy a predetermined matching condition. The “matching condition” is, for example, that a degree of matching between the external environment information and the map information is equal to or greater than a threshold. The map information stored in the storage unit 120 includes the map information based on the external environment information obtained by the external environment recognition unit 110 during the past traveling of the vehicle 1.

In the private land section control, the movement control unit 130 causes the vehicle 1 to travel based on map information corresponding to a current travel route of the vehicle 1 among a plurality of pieces of map information associated with routes during past traveling stored in the storage unit 120 and the external environment information obtained by the external environment recognition unit 110. The “map information corresponding to a current travel route” is map information associated with a travel route during the past traveling that satisfies a predetermined matching condition with the current travel route. The route during the past traveling includes, for example, a route along which the vehicle 1 travels by the general road assistance control when transitioning from the general road assistance control to the private land section control. Specifically, when the vehicle 1 enters a private land from a general road, a traveling direction of the vehicle 1 traveling on the general road or the like is included.

The movement control unit 130 transitions to the private land section control when an approval operation for approving the transition to the private land section control is received from the user, and the vehicle 1 enters a travelable area where traveling by the private land section control is possible. The map information is map information on a region including the determination area for determining the travel condition of the vehicle 1 and the travelable area where the traveling by the private land section control is possible.

The travel condition in the private land section control includes at least one of conditions that a state in which a travel speed of the vehicle 1 in the determination area exceeds a first speed does not continue for a predetermined time or more, and that the travel speed of the vehicle 1 in the determination area does not exceed a second speed. The first speed is, for example, 15 [km/h]. The predetermined time is, for example, a time for traveling 50 [m] at a speed of 15 [km/h] or more. The second speed is, for example, 30 [km/h]. The travel condition in the private land section control includes that a state of a device of the vehicle 1 used for the private land section control is normal. Examples of the “device” include the camera 10, the radar device 12, the LIDAR 14, and the vehicle sensor 40. When an ECU for APS is provided, the “device”includes the APS_ECU.

The movement control unit 130 performs, for example, control to park the vehicle 1 at the target position by the private land section control. The target position includes, for example, a parking lot (garage, carport, or the like) of a private land. The private land section control for parking the vehicle 1 at the target position is performed based on route information when the vehicle 1 was parked at the target position in the past. The movement control unit 130 performs, for example, control to cause the vehicle 1 to leave from a predetermined position by the private land section control. The predetermined position includes, for example, a parking lot (garage, carport, or the like) of a private land. The predetermined position is an operation start position when the vehicle 1 leaves.

The travel driving force output device 92 outputs, to driving wheels, a travel driving force (torque) for the vehicle to travel. The travel driving force output device 92 includes, for example, a combination of an internal combustion engine, an electric motor, a transmission, and the like, and an electronic control unit (ECU) that controls the combination. The ECU controls the above configuration according to information received from the movement control unit 130 or information received from the driving operator 80.

The brake device 94 includes, for example, a brake caliper, a cylinder that transmits a hydraulic pressure to the brake caliper, an electric motor that generates the hydraulic pressure in the cylinder, and a brake ECU. The brake ECU controls the electric motor according to the information received from the movement control unit 130 or the information received from the driving operator 80, and outputs a braking torque to each wheel according to a braking operation.

The steering device 96 includes, for example, a steering ECU and an electric motor. The electric motor changes an orientation of a steered wheel, for example, by applying a force to a rack-and-pinion mechanism. The steering ECU drives the electric motor according to the information received from the movement control unit 130 or the information received from the driving operator 80 to change the orientation of the steered wheel.

### Operation of Vehicle 1

### (First Operation Example)

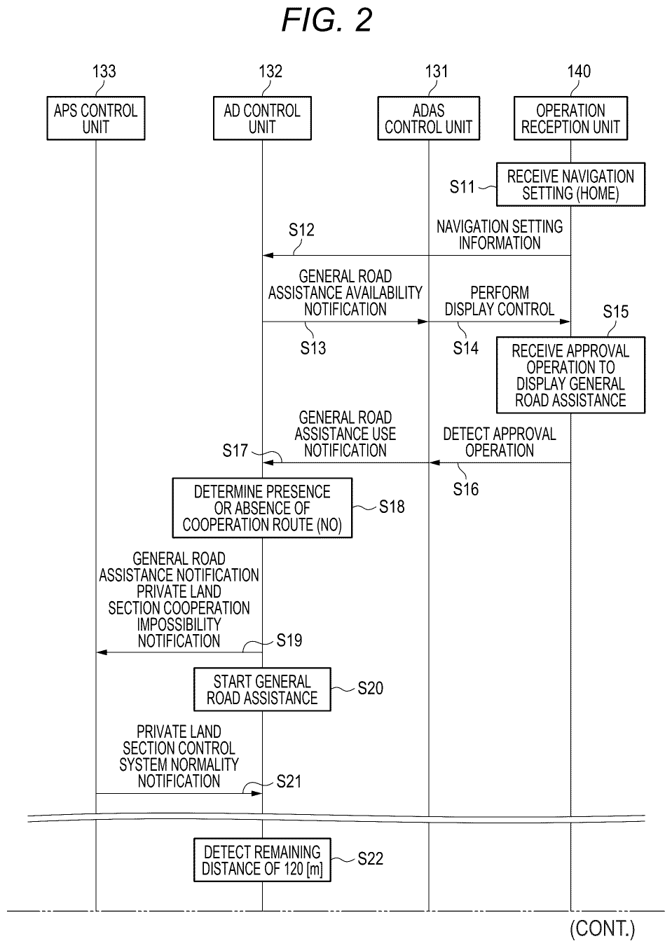

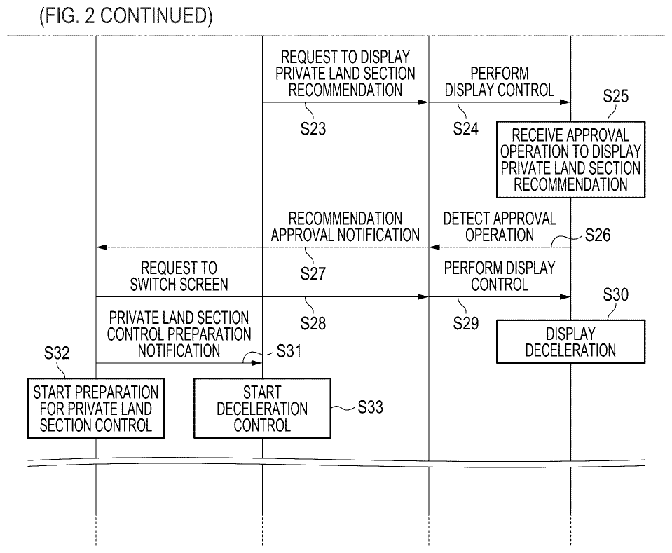

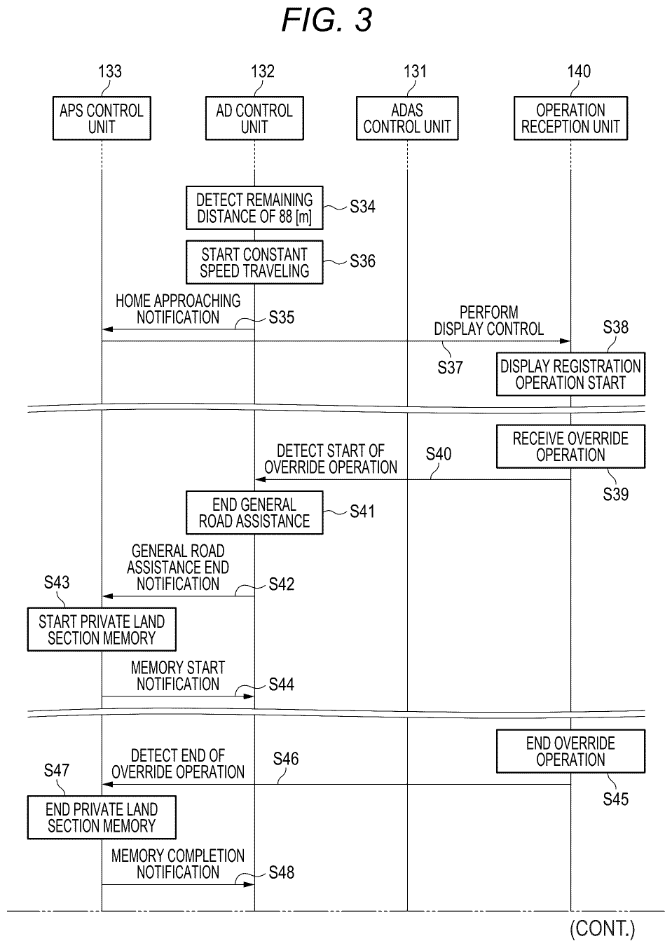

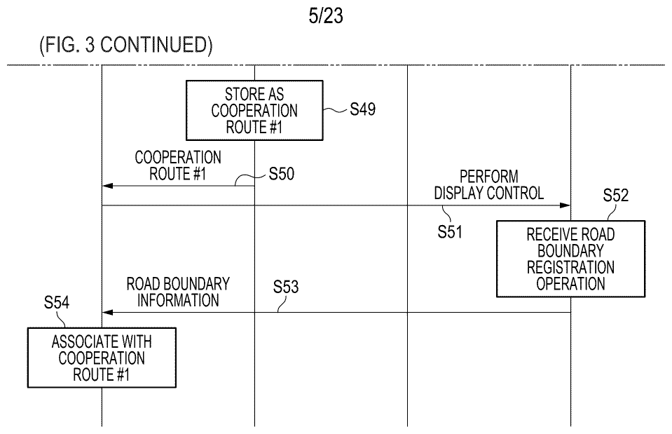

FIGS. 2 and 3 are sequence diagrams illustrating a first operation example of the vehicle 1. The APS control unit 133, the AD control unit 132, and the ADAS control unit 131 are control units included in the movement control unit 130 (see FIG. 1). An operation reception unit 140 is the navigation HMI 62, the HMI 30, or the driving operator 80 (see FIG. 1). The first operation example is an operation example in a case where a user who gets on the vehicle 1 returns home from a destination and causes the vehicle 1 to enter a parking lot at home. The target position of the vehicle 1 is the parking lot at home. However, in the first operation example, it is assumed that route information when the vehicle 1 is caused to enter the parking lot at home is not yet stored in the storage unit 120, and thus the vehicle 1 cannot be caused to enter the parking lot at home by the private land section control.

First, the user operates, for example, the navigation HMI 62 of the navigation device 60 to perform navigation setting in which the target position of the vehicle 1 is the parking lot at home.

The operation reception unit 140 receives the navigation setting from the user with the target position being the parking lot at home (step S11). The operation reception unit 140 transmits the received navigation setting information to the AD control unit 132 (step S12).

Based on the received navigation setting information, the AD control unit 132 recognizes that the vehicle can proceed to the vicinity of the home by the general road assistance control and that the vehicle does not arrive at the parking lot at home by the general road assistance control alone. The AD control unit 132 notifies the ADAS control unit 131 that the general road assistance control is available (step S13).

The ADAS control unit 131 performs display control on the operation reception unit 140 to display on the navigation HMI 62 that the general road assistance control is available in the navigation to the home set by the user (step S14).

In order to notify the user, the operation reception unit 140 displays on the navigation HMI 62 that the general road assistance control is available (step S15). It is assumed that the user approves the use of the general road assistance control in response to this notification. The operation reception unit 140 receives an approval operation from the user on the navigation HMI 62 (step S15). The operation reception unit 140 outputs, to the ADAS control unit 131, an operation detection signal notifying that the approval operation from the user is detected (step S16).

The ADAS control unit 131 notifies the AD control unit 132 that the user uses the general road assistance control, based on the operation detection signal from the operation reception unit 140 (step S17).

In travel control of the vehicle 1 to the parking lot at home of the user, the AD control unit 132 determines whether a route cooperating with a travel route of the general road assistance control is stored in the storage unit 120, that is, determines presence or absence of a cooperation route (step S18). As described above, the route information when the vehicle 1 is caused to enter the parking lot at home is not yet stored in the storage unit 120. Therefore, the determination of the presence or absence of the cooperation route is “NO”. The AD control unit 132 notifies the APS control unit 133 that the general road assistance control is used and that there is no cooperation route, that is, the cooperation of the private land section control is impossible (step S19). Then, the AD control unit 132 starts the travel control of the vehicle 1 by the general road assistance (step S20).

When receiving a general road assistance notification and a private land section cooperation impossibility notification, the APS control unit 133 notifies the AD control unit 132 that a state of a private land section control system is normal and travel control by the private land section control can be performed (step S21).

The AD control unit 132 detects, based on a signal received by the GNSS receiver 61, that a travel point of the vehicle 1 traveling by the general road assistance control is a point at a remaining distance of 120 [m] to the parking lot at home which is the target position (step S22). The AD control unit 132 requests the ADAS control unit 131 to display a private land section control recommendation for recommending the travel control by the private land section control (step S23).

In the travel control of the vehicle 1 to the home, the ADAS control unit 131 performs the display control on the operation reception unit 140 to display the recommendation of the private land section control on the navigation HMI 62 (step S24).

The operation reception unit 140 displays, on the navigation HMI 62, a recommendation to use the private land section control (step S25). It is assumed that the user approves the use of the private land section control in response to this display. The operation reception unit 140 receives an approval operation from the user on the navigation HMI 62 (step S25). The operation reception unit 140 outputs, to the ADAS control unit 131, an operation detection signal notifying that the approval operation from the user is detected (step S26).

The ADAS control unit 131 notifies the APS control unit 133 that the user approves the private land section control recommendation, based on the operation detection signal from the operation reception unit 140 (step S27).

When receiving a recommendation approval notification, the APS control unit 133 requests the ADAS control unit 131 to switch a screen of the navigation HMI 62 in order to cause the vehicle 1 to travel in accordance with the private land section control (step S28).

The ADAS control unit 131 performs the display control on the operation reception unit 140 to display, on the navigation HMI 62, a screen for causing the vehicle 1 to travel in accordance with the private land section control (step S29).

The operation reception unit 140 displays on the navigation HMI 62 that a travel speed of the vehicle 1 is reduced (step S30). For example, the operation reception unit 140 displays “Deceleration for private land section memory” on the navigation HMI 62. The purpose of the private land section memory is to record a travel route when the user manually drives the vehicle 1 to enter the parking lot at home.

When receiving the recommendation approval notification, the APS control unit 133 notifies the AD control unit 132 that preparation for the private land section control is performed (step S31). Then, the APS control unit 133 starts the preparation for the private land section control (step S32).

When receiving a private land section control preparation notification, the AD control unit 132 starts deceleration control of the vehicle 1 (step S33). This deceleration control is, for example, control such that the travel speed is 15 [km/h] when the travel point of the vehicle 1 reaches a remaining distance of 88 [m] to the parking lot at home.

Then, in FIG. 3, the AD control unit 132 detects, based on a signal received by the GNSS receiver 61, that the travel point of the vehicle 1 is a point at a remaining distance of 88 [m] to the parking lot at home which is the target position (step S34). The AD control unit 132 starts constant speed traveling (step S35). The AD control unit 132 starts the constant speed traveling at, for example, 15 [km/h] by the deceleration control. The AD control unit 132 transmits, to the APS control unit 133, a home approaching notification indicating that the vehicle 1 is approaching the home which is the target position (step S36).

When receiving the home approaching notification, the APS control unit 133 performs the display control on the operation reception unit 140 to display, on the navigation HMI 62, a screen for moving the vehicle 1 to the parking lot at home by a driving operation of the user (step S37).

The operation reception unit 140 displays, on the navigation HMI 62, a registration operation start, which is a screen display for moving the vehicle 1 to the parking lot at home by the driving operation of the user (step S38). For example, the operation reception unit 140 displays “Start private land section memory. Please drive on driveway.” on the navigation HMI 62. The driveway is, for example, a travel route to a target position (parking lot at home) to which the vehicle 1 moves on a private land. It is assumed that the user starts an override operation of driving on the driveway in response to this display. The operation reception unit 140 receives the override operation of the user (step S39). The operation reception unit 140 outputs, to the AD control unit 132, a start detection signal for notifying that the start of the override operation of the user is detected (step S40).

The AD control unit 132 ends the travel control of the vehicle 1 by the general road assistance, based on the start detection signal from the operation reception unit 140 (step S41). The AD control unit 132 notifies the APS control unit 133 that the control of the general road assistance is ended (step S42).

The APS control unit 133 starts the private land section memory that stores route information on the override operation started by the user in the storage unit 120 (step S43). The APS control unit 133 notifies the AD control unit 132 that the private land section memory is started (step S44). The APS control unit 133 may control the operation reception unit 140 to display that a private land section in the override operation is being registered. The APS control unit 133 may control the navigation HMI 62 to display, for example, the override operation of the user during execution of the private land section memory.

The operation reception unit 140 ends the reception of the override operation of the driveway by the user (step S45). The operation reception unit 140 detects that the override operation is ended, for example, when the vehicle 1 enters the parking lot at home and is stopped. The operation reception unit 140 outputs, to the APS control unit 133, an end detection signal notifying that the end of the override operation is detected (step S46).

The APS control unit 133 ends the private land section memory that stores the route information on the override operation in the driveway, based on the end detection signal from the operation reception unit 140 (step S47). At this time, depending on a data processing timing, storage in a non-volatile memory may not be ended. The APS control unit 133 notifies the AD control unit 132 that the private land section memory is completed (step S48).

When receiving a memory completion notification, the AD control unit 132 stores the route cooperating with the travel route of the general road assistance control in the storage unit 120 as a cooperation route #1 (step S49). For example, when the vehicle 1 approaches home on a route on which the vehicle 1 travels this time and enters a private road in a private land from a general road, the AD control unit 132 stores, as the cooperation route #1, route information such as a direction from which the vehicle 1 travels on the general road and enters the private road, and whether the vehicle 1 enters the private road by turning left or turning right. The AD control unit 132 transmits the stored information on the cooperation route #1 to the APS control unit 133 (step S50).

The APS control unit 133 performs the display control on the operation reception unit 140 to display, on the navigation HMI 62, a screen representing map information including a travel route on which the user performs the override operation (step S51). The user sets a road boundary on the map information displayed on the navigation HMI 62. The road boundary indicates a boundary of a region in which the vehicle 1 can travel by the private land section control, that is, a boundary of a travelable area.

The operation reception unit 140 receives a road boundary registration operation for registering a road boundary set by a user operation (step S52). The operation reception unit 140 transmits road boundary information on the set road boundary to the APS control unit 133 (step S53).

The APS control unit 133 stores the received cooperation route #1 and road boundary information in the storage unit 120 in association with the information on the override operation stored by the private land section memory (step S54).

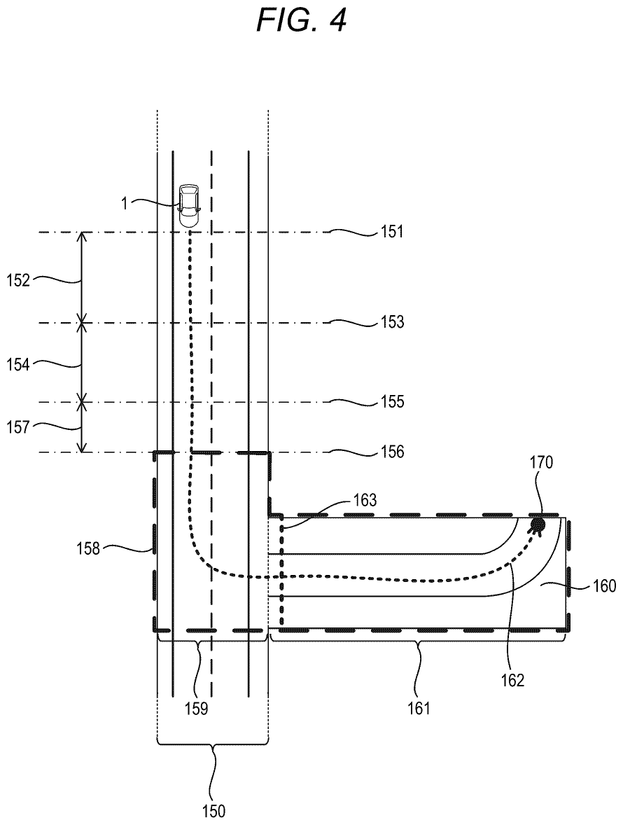

FIG. 4 is a diagram illustrating an initial example of a state in which the vehicle 1 on which the user gets is traveling with a parking lot 170 at home as the target position. The initial example is an example in a situation in which route information when the vehicle 1 enters the parking lot 170 at home is not yet stored, as described in the first operation example of FIGS. 2 and 3. In FIG. 4, the vehicle 1 is traveling on a general road 150 by the travel control of the general road assistance. A current travel position of the vehicle 1 is a point 151 where a remaining distance to the parking lot 170 at home is 120 [m].

When the vehicle 1 reaches the point 151 at the remaining distance of 120 [m], the vehicle 1 starts recommending the user to apply the private land section control to the travel control until the vehicle 1 enters the parking lot 170 at home. When an approval of the recommendation from the user is received, the vehicle 1 starts deceleration. A section in which the recommendation is made to the user is a recommendation section 152, and a position where the approval of the recommendation is received from the user is an approval point 153.

The vehicle 1 decelerates such that a speed becomes 15 [km/h] at a point where the remaining distance to the parking lot 170 at home is 88 [m]. A section in which the deceleration control is performed to the speed of 15 [km/h] is a deceleration section 154, and a position of the remaining distance of 88 [m] where the deceleration is completed is a deceleration completion point 155.

When the vehicle 1 reaches the deceleration completion point 155 at the remaining distance of 88 [m], the vehicle 1 performs constant speed traveling at 15 [km/h]. Then, the vehicle 1 prompts the user to perform an override operation in which the user travels along a travel route to the parking lot 170 at home by manual driving. In response to this, the user starts the override operation by manual driving. A position where the user starts the override operation is an override start point 156, and a section of the constant speed traveling until the override operation is started is a constant speed section 157.

When the override operation by the user is started, the private land section memory that stores the route information on the override operation in the storage unit 120 is started. A section in which the private land section memory is performed is a section from the start of the override operation until the vehicle 1 enters the parking lot 170 at home, and is a private land section memory section 158 in a range surrounded by a thick broken line in FIG. 4. The private land section memory section 158 includes a general road region 159, which is a region of the general road 150, and a driveway (private road) 161 in a private land 160. The user causes the vehicle 1 to travel on a travel route in the private land section memory section 158 by manual driving.

In this way, the vehicle 1 turns left from the general road 150 and travels to the driveway 161 of the private land 160 in a section from the point 151 at the remaining distance of 120 [m] to the parking lot 170 at home, as indicated by a movement route 162 indicated by a broken line. Then, information on the movement route 162 in the private land section memory section 158 is stored in the storage unit 120 together with the cooperation route #1 that cooperates with the travel route of the general road assistance control. At this time, in the private land section memory section 158, a road boundary 163 indicating a boundary of a region in which the vehicle 1 can travel by the private land section control is displayed. A position of the road boundary 163 is configured to be set to any position by a user operation. The set road boundary 163 is stored in association with the movement route 162 and the cooperation route #1.

### (Second Operation Example)

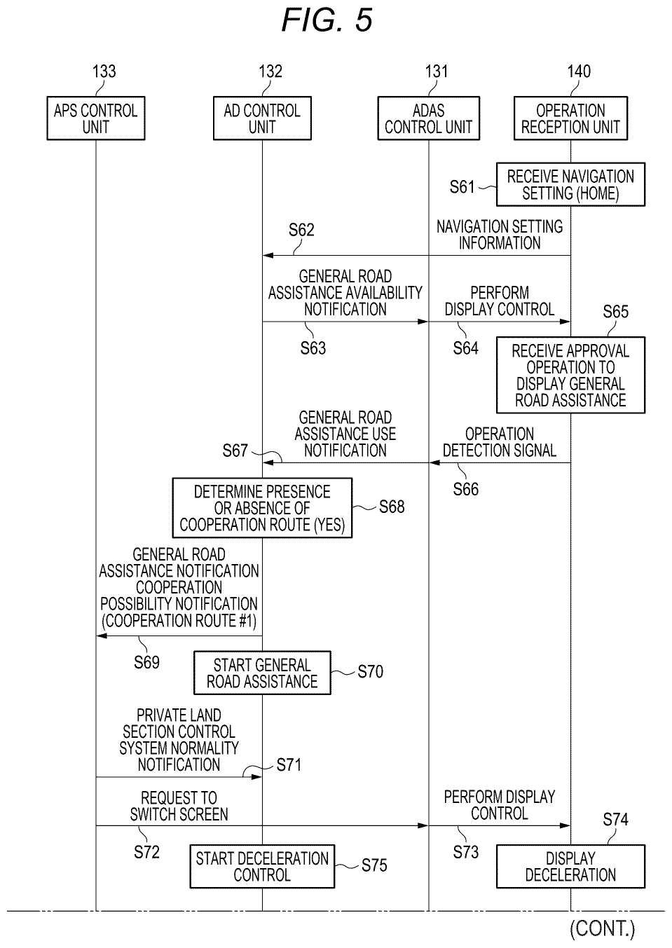

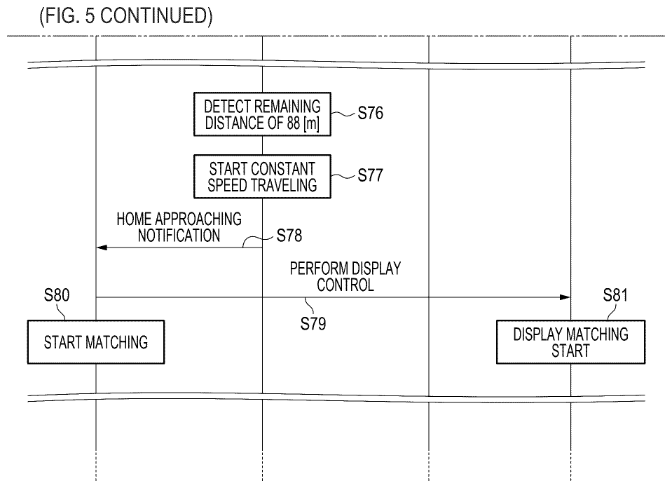

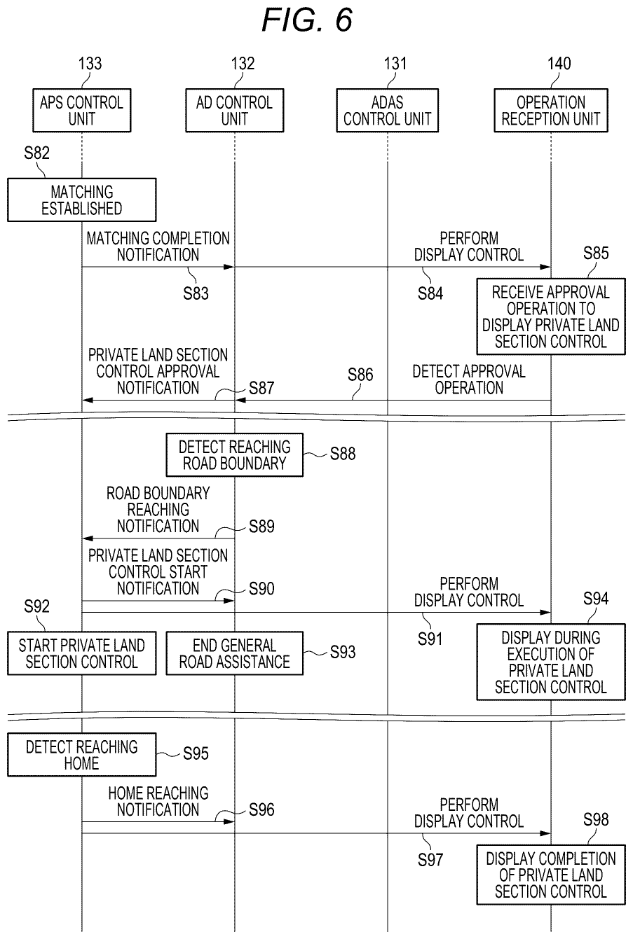

FIGS. 5 and 6 are sequence diagrams illustrating a second operation example of the vehicle 1. The second operation example is the same as the first operation example in that the second operation example is an operation example in which a user who gets on the vehicle 1 returns home from a destination and causes the vehicle 1 to enter a parking lot at home, but is different from the first operation example in that route information when the vehicle 1 is caused to enter the parking lot at home is stored in the storage unit 120 and the vehicle 1 can be caused to enter the parking lot at home by the private land section control.

In FIG. 5, processing from step S61 to step S67 is similar to processing from step S11 to step S17 in the first operation example in FIG. 2.

In travel control of the vehicle 1 to the parking lot at home of the user, the AD control unit 132 determines whether a route cooperating with a travel route of the general road assistance control is stored in the storage unit 120, that is, determines presence or absence of a cooperation route (step S68). As described above, the cooperation route #1 when the vehicle 1 enters the parking lot at home is stored in the storage unit 120 in association with the information at the time of the override operation stored by the private land section memory and the road boundary information. Therefore, the determination of the presence or absence of the cooperation route is “YES”. The AD control unit 132 notifies the APS control unit 133 that the general road assistance control is used and that there is a cooperation route, that is, the cooperation of the private land section control is likely to be possible (step S69). The stored cooperation route is, for example, the “cooperation route #1” stored in step S49 of the first operation example. The AD control unit 132 starts the travel control of the vehicle 1 by the general road assistance (step S70).

When receiving a general road assistance notification and a private land section cooperation possibility notification, the APS control unit 133 notifies the AD control unit 132 that a state of a private land section control system is normal and travel control by the private land section control can be performed (step S71). When receiving the general road assistance notification and the private land section cooperation possibility notification, the APS control unit 133 requests the ADAS control unit 131 to switch a screen of the navigation HMI 62 in order to cause the vehicle 1 to travel in accordance with the private land section control (step S72).

The ADAS control unit 131 performs the display control on the operation reception unit 140 to display, on the navigation HMI 62, a screen for causing the vehicle 1 to travel in accordance with the private land section control (step S73).

The operation reception unit 140 displays on the navigation HMI 62 that a travel speed of the vehicle 1 is reduced (step S74). The display on the navigation HMI 62 to decelerate the travel speed is an example of the “second notification” of the present disclosure. For example, the operation reception unit 140 displays “Deceleration for matching” on the navigation HMI 62. The purpose of the matching is to check a degree of matching between current external environment information obtained by the external environment recognition unit 110 and map information associated with the cooperation route #1 stored in the storage unit 120.

When the deceleration is displayed by the operation reception unit 140, the AD control unit 132 starts deceleration control of the vehicle 1 (step S75). This deceleration control is performed such that the travel speed is 15 [km/h] when the travel point of the vehicle 1 reaches a remaining distance of 88 [m] to the parking lot at home, for example. The AD control unit 132 detects, based on a signal received by the GNSS receiver 61, that the travel point of the vehicle 1 is a point at a remaining distance of 88 [m] to the parking lot at home (step S76). The AD control unit 132 starts constant speed traveling at, for example, 15 [km/h] by the deceleration control (step S77). The AD control unit 132 transmits, to the APS control unit 133, a home approaching notification indicating that the vehicle 1 is approaching the home which is the target position (step S78).

When receiving the home approaching notification, the APS control unit 133 performs the display control on the operation reception unit 140 to display, on the navigation HMI 62, a screen for notifying the user of the start of the matching (step S79). Then, the APS control unit 133 starts the matching (step S80).

The operation reception unit 140 displays, on the navigation HMI 62, a matching start, which is a screen display for notifying that the matching is started (step S81). For example, the operation reception unit 140 displays “Start matching for private land section control.” on the navigation HMI 62. The purpose of the private land section control is to perform control to cause the vehicle 1 to enter the parking lot 170 at home.

Then, in FIG. 6, when the matching is established (step S82), the APS control unit 133 notifies the AD control unit 132 that the matching is completed (step S83). The matching is established when a degree of matching between the current external environment information obtained by the external environment recognition unit 110 and, for example, the map information associated with the cooperation route #1 is equal to or greater than a threshold.

The AD control unit 132 performs the display control on the operation reception unit 140 to display on the navigation HMI 62 that the matching is completed and the private land section control is possible in traveling to the parking lot at home because the matching is completed (step S84). The AD control unit 132 performs the display control on the operation reception unit 140 to prompt the user to perform an approval operation of the control transition such that the travel control of the vehicle 1 transitions from the general road assistance control to the private land section control. The display control of the navigation HMI 62 prompting the approval operation of the control transition is an example of the “first notification” of the present disclosure.

In order to notify the user, the operation reception unit 140 displays on the navigation HMI 62 that the matching is completed and the private land section control is possible (step S85). It is assumed that the user approves the use of the private land section control in response to this notification. The operation reception unit 140 receives an approval operation from the user on the navigation HMI 62 (step S85). The operation reception unit 140 outputs, to the AD control unit 132, an operation detection signal notifying that the approval operation from the user is detected (step S86).

The AD control unit 132 notifies the APS control unit 133 that the user approves the private land section control, based on the operation detection signal from the operation reception unit 140 (step S87). Then, the AD control unit 132 detects that the vehicle reaches a road boundary by the travel control of the general road assistance (step S88). The road boundary is, for example, the position of the road boundary set by the user in the first operation example described above. The AD control unit 132 notifies the APS control unit 133 that the vehicle 1 reaches the road boundary (step S89).

The APS control unit 133 notifies the AD control unit 132 that the travel control of the vehicle 1 by the private land section control is started (step S90). The APS control unit 133 performs the display control on the operation reception unit 140 to display on the navigation HMI 62 that the vehicle 1 is caused to travel by the private land section control (step S91). Then, the APS control unit 133 starts the private land section control of the vehicle 1 (step S92). In step S85 described above, since the user approves the use of the private land section control, the APS control unit 133 starts the private land section control, but the present disclosure is not limited thereto. For example, when the user does not approve the use of the private land section control, the APS control unit 133 does not start the private land section control because no private land section control approval notification is issued.

When receiving a private land section control start notification, the AD control unit 132 ends the travel control of the vehicle 1 by the general road assistance (step S93).

The operation reception unit 140 displays, on the navigation HMI 62, a screen during execution of the private land section control for notifying that the travel control of the vehicle 1 is being performed by the private land section control (step S94).

When the vehicle 1 enters the parking lot 170 at home by the private land section control, the APS control unit 133 detects reaching of the vehicle 1 at home (step S95). The APS control unit 133 notifies the AD control unit 132 of reaching the home (step S96). The APS control unit 133 performs the display control on the operation reception unit 140 to display on the navigation HMI 62 that the vehicle 1 reaches the home and the travel control by the private land section control is completed (step S97).

The operation reception unit 140 displays, on the navigation HMI 62, a private land section control completion screen for notifying that the travel control by the private land section control is completed (step S98).

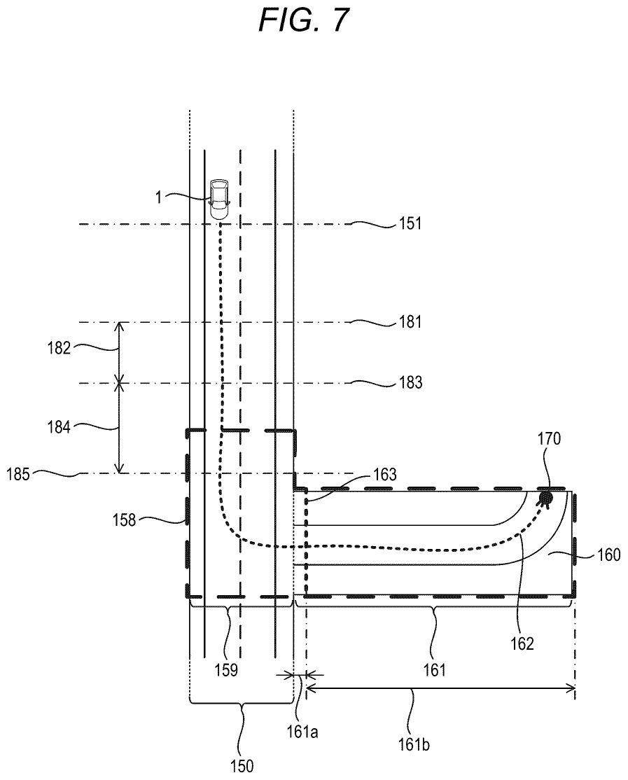

FIG. 7 is a diagram illustrating a next example of the state in which the vehicle 1 on which the user gets is traveling with the parking lot 170 at home as the target position. The next example is a travel example in a situation in which the route information when the vehicle 1 enters the parking lot 170 at home is stored, as described in the second operation example of FIGS. 5 and 6. In FIG. 7, the vehicle 1 is traveling on the general road 150 along the same route as the initial example (see FIG. 4) by the travel control of the general road assistance. A current travel position of the vehicle 1 is the point 151 where the remaining distance to the parking lot 170 at home is 120 [m]. The point 151 is the same position as the point 151 at the remaining distance of 120 [m] shown in the initial example.

When the vehicle 1 passes through the point 151 and travels to a predetermined position, the vehicle 1 starts deceleration such that a speed becomes 15 [km/h] at a point where the remaining distance to the parking lot 170 at home is 88 [m]. The position where the deceleration is started is a deceleration start point 181.

When the vehicle 1 starts to decelerate, the vehicle 1 notifies the user to confirm a travel condition as to whether the vehicle 1 can travel by the private land section control. A section in which the deceleration control is performed is a deceleration section 182, and a position of the remaining distance of 88 [m] where the deceleration is completed is a deceleration completion point 183.

When the vehicle 1 reaches the deceleration completion point 183, the vehicle 1 starts determination of success or failure of matching, which is a travel condition for performing the private land section control, between current external environment information obtained by the external environment recognition unit 110 and route information associated with, for example, the cooperation route #1 stored in the storage unit 120. A section in which matching determination processing is executed is a matching section 184. A position where the matching is established by performing the matching determination is a matching established point 185. When the matching determination is started and the vehicle enters the private land section memory section 158 in which the route information to be matched is present, the determination of the success or failure of the matching is completed. A section in which the travel condition in the private land section control is determined is a determination area. The vehicle 1 performs constant speed traveling at 15 [km/h] during matching.

When the matching is established, the private land section control based on the route information stored in the storage unit 120 is applied. In FIG. 7, as the movement route 162 in the private land section memory section 158 surrounded by a thick broken line, the movement route 162 in the private land section memory section 158 stored in the storage unit 120 in the initial example (see FIG. 4) is applied. The private land section memory section 158 includes the general road region 159 of the general road 150 and the driveway (private road) 161 in the private land 160. In the private land section memory section 158, the road boundary 163 indicating a boundary of a region in which the vehicle 1 can travel by the private land section control is set. The transition to the travel by the private land section control occurs when the vehicle 1 reaches a position of the road boundary 163.

In the private land section memory section 158, the vehicle 1 performs the travel control of the general road assistance in the general road region 159 in the general road 150 and an excluded private road region 161a on a general road region 159 side with respect to the road boundary 163 in the driveway 161. Then, the vehicle 1 performs the travel control of the private land section control in a set private road region 161b on a parking lot 170 side with respect to the road boundary 163 in the driveway 161. The vehicle 1 switches from the travel control of the general road assistance to the travel control of the private land section control with the road boundary 163 as a boundary. Even when it is determined that the matching is established and the travel condition is satisfied, the vehicle 1 travels by the general road assistance control until the vehicle 1 enters the set private road region 161b. The set private road region 161b is a travelable area where the vehicle 1 can travel by the private land section control. The travelable area is an area set by the user setting the road boundary 163.

However, if the map information only includes, for example, the travelable area where the traveling by the private land section control is possible, it is not possible to determine the success or failure of matching based on the map information and the external environment information unless the vehicle 1 enters the travelable area.

On the other hand, since the control device 100 of the present invention uses the map information on the region including the determination area for determining the travel condition in the private land section control and the travelable area where the traveling by the private land section control is possible, it is possible to determine the success or failure of matching before entering the travelable area. Therefore, it is possible to quickly determine the travel condition, and the transition of the control between the general road assistance control and the private land section control can be smoothed.

According to the control device 100, the travelable area in the region indicated by the map information is an area determined by the user setting the road boundary 163. Therefore, since it is possible to determine, by the setting of the user, a range of the travelable area where the traveling is possible by the private land section control, it is possible to set a position at which the transition is performed between the general road assistance control and the private land section control to an appropriate position according to a surrounding environment of a travel route. Accordingly, the transition of the control between the general road assistance control and the private land section control can be smoothed.

In addition, according to the control device 100, the vehicle 1 is caused to travel in the general road assistance control until the vehicle 1 enters the travelable area in the private land section control even when it is determined that the travel condition in the private land section control is satisfied. Therefore, it is possible to perform appropriate mode transition according to a surrounding environment of a route on which the vehicle 1 travels.

### (Third Operation Example)

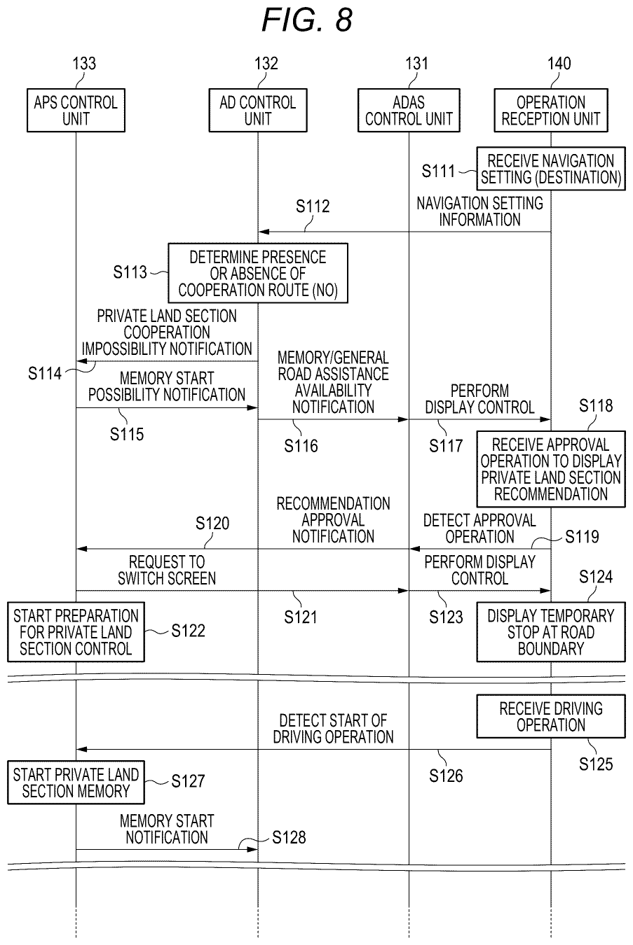

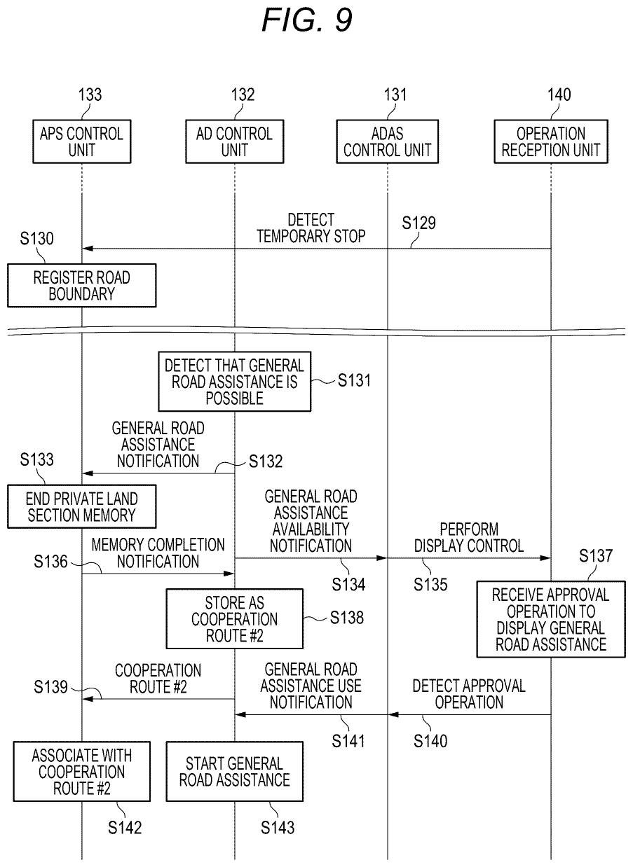

FIGS. 8 and 9 are sequence diagrams illustrating a third operation example of the vehicle 1. The third operation example is an operation example in a case where a user who gets on the vehicle 1 causes the vehicle 1 to leave a parking lot at home and goes out. An operation start position of the vehicle 1 is the parking lot at home. However, in the third operation example, it is assumed that route information when the vehicle 1 is caused to leave the parking lot at home is not yet stored in the storage unit 120, and thus the vehicle 1 cannot be caused to leave the parking lot at home by the private land section control.

First, the user operates, for example, the navigation HMI 62 of the navigation device 60 to perform navigation setting of a destination which is a target position of the vehicle 1.

The operation reception unit 140 receives the navigation setting of the destination (step S111), and transmits the received navigation setting information to the AD control unit 132 (step S112).

In travel control of the vehicle 1 from the home parking lot to the destination, the AD control unit 132 determines whether a route cooperating with a travel route of the general road assistance control is stored in the storage unit 120, that is, determines presence or absence of a cooperation route along which the vehicle 1 travels in a private land between the home parking lot and a general road (step S113). As described above, the route information when the vehicle 1 is caused to leave the parking lot at home is not yet stored in the storage unit 120. Therefore, the determination of the presence or absence of the cooperation route is “NO”. The AD control unit 132 notifies the APS control unit 133 that there is no cooperation route, that is, the cooperation of the private land section control is impossible (step S114).

When receiving a private land section cooperation impossibility notification, the APS control unit 133 notifies the AD control unit 132 that the private land section memory can be started (step S115).

The AD control unit 132 notifies the ADAS control unit 131 that memory processing of the private land section control and the travel control of the general road assistance after the memory processing are available (step S116).

In the travel control of the vehicle 1 to the current destination, the ADAS control unit 131 performs display control on the operation reception unit 140 to display a recommendation of the memory processing of the private land section control on the navigation HMI 62 (step S117).

The operation reception unit 140 displays, on the navigation HMI 62, the recommendation of the memory processing of the private land section control (step S118). The operation reception unit 140 may further display that the travel control of the general road assistance is available after the memory processing of the private land section control is executed. It is assumed that the user approves to execute the memory processing of the private land section control in response to this display. The operation reception unit 140 receives an approval operation from the user on the navigation HMI 62 (step S118). The operation reception unit 140 outputs, to the ADAS control unit 131, an operation detection signal notifying that the approval operation from the user is detected (step S119).

The ADAS control unit 131 notifies the APS control unit 133 that the user approves the recommendation of the memory processing of the private land section control, based on the operation detection signal from the operation reception unit 140 (step S120).

When receiving a recommendation approval notification, the APS control unit 133 requests the ADAS control unit 131 to switch a screen of the navigation HMI 62 in order to allow the user to manually drive the vehicle 1 to leave the parking lot (step S121). Then, the APS control unit 133 starts preparation for the memory processing of the private land section control (step S122).

When receiving the request from the APS control unit 133, the ADAS control unit 131 performs the display control on the operation reception unit 140 to display, on the navigation HMI 62, a screen for allowing the user to manually drive the vehicle 1 to leave the parking lot (step S123).

The operation reception unit 140 displays on the navigation HMI 62 that after the vehicle 1 leaves the parking lot, the vehicle 1 is caused to travel on a driveway, and is to be temporarily stopped at a road boundary of the driveway (step S124). For example, the operation reception unit 140 displays “Please drive on driveway, temporarily stop at road boundary, and then go out to general road” on the navigation HMI 62. The road boundary is a position indicating a boundary portion of the driveway where the travel is possible by the private land section control, and is a boundary that can be freely set by the user. Here, it is assumed that a manual driving operation of the vehicle 1 by the user is started. The operation reception unit 140 receives a driving operation by the user (step S125). The operation reception unit 140 outputs, to the APS control unit 133, an operation detection signal notifying that the driving operation of the user is detected (step S126).

The APS control unit 133 starts the private land section memory that stores, in the storage unit 120, route information on a leaving operation of the vehicle 1 in the driveway started by the user, based on the operation detection signal from the operation reception unit 140 (step S127). The APS control unit 133 notifies the AD control unit 132 that the private land section memory is started (step S128). The APS control unit 133 may control the operation reception unit 140 to display that private land section in the leaving operation is being registered. The APS control unit 133 may control the navigation HMI 62 to display, for example, the leaving operation of the user during execution of the private land section memory.

Then, in FIG. 9, it is assumed that the vehicle 1 driven by the user leaves the parking lot, travels on a private road in the private land, and is temporarily stopped at a certain position before entering the general road. The operation reception unit 140 outputs, to the APS control unit 133, a stop notification signal for notifying that the vehicle 1 is temporarily stopped (step S129).

When receiving the stop notification signal from the operation reception unit 140, the APS control unit 133 registers a current position where the vehicle 1 is temporarily stopped as the position of the road boundary (step S130). After temporarily stopping the vehicle 1, the user drives the vehicle 1 from the private road on which the vehicle 1 has been traveling to the general road by a driving operation of the user.

The AD control unit 132 detects that the travel control of the vehicle 1 by the general road assistance is possible based on the fact that the vehicle 1 starts to travel to the general road (step S131). The AD control unit 132 notifies the APS control unit 133 that the travel control by the general road assistance is possible (step S132).

When receiving a general road assistance notification from the AD control unit 132, the APS control unit 133 ends the private land section memory that stores the route information on the leaving operation (step S133).

The AD control unit 132 notifies the ADAS control unit 131 that the travel control of the vehicle 1 by the general road assistance is available (step S134).

The ADAS control unit 131 performs the display control on the operation reception unit 140 to display on the navigation HMI 62 that the general road assistance control is available in the navigation to the destination set by the user (step S135).

The APS control unit 133 notifies the AD control unit 132 that the private land section memory is completed (step S136).

In order to notify the user, the operation reception unit 140 displays on the navigation HMI 62 that the general road assistance control is available (step S137). It is assumed that the user approves the use of the general road assistance control in response to this notification. The operation reception unit 140 receives an approval operation from the user on the navigation HMI 62 (step S137).

When receiving a memory completion notification, the AD control unit 132 stores the route cooperating with the travel route of the general road assistance control in the storage unit 120 as a cooperation route #2 (step S138). For example, when the vehicle 1 travels from a private road in a private land to a general road on a route on which the vehicle 1 travels this time, the AD control unit 132 stores, as the cooperation route #2, route information such as a direction from which the vehicle 1 travels on the general road, for example, whether the vehicle 1 enters the general road by turning left or turning right. The AD control unit 132 transmits the stored information on the cooperation route #2 to the APS control unit 133 (step S139).

The operation reception unit 140 outputs, to the ADAS control unit 131, an operation detection signal notifying that the approval operation of the use of the general road assistance control from the user is detected (step S140).

The ADAS control unit 131 notifies the AD control unit 132 that the user uses the general road assistance control, based on the operation detection signal from the operation reception unit 140 (step S141).

When receiving the cooperation route #2 from the AD control unit 132, the APS control unit 133 stores, in the storage unit 120, the route information on the leaving operation stored by the private land section memory and the road boundary registered in step S130 in association with the cooperation route #2 (step S142).

When receiving a general road assistance use notification, the AD control unit 132 starts the travel control of the vehicle 1 by the general road assistance (step S143).

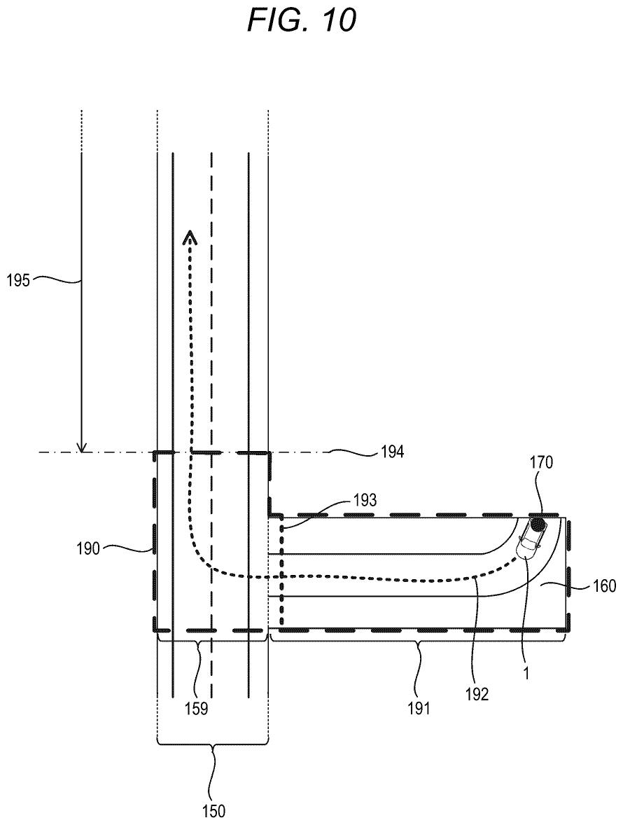

FIG. 10 is a diagram illustrating an initial example of a state in which the vehicle 1 on which the user gets travels with the parking lot 170 at home as an operation start position. The initial example is an example in a situation in which route information when the vehicle 1 leaves the parking lot 170 at home is not yet stored, as described in the third operation example of FIGS. 8 and 9. FIG. 10 illustrates a situation in which a destination of the vehicle 1 is set in the navigation device 60 to make the vehicle 1 toward the destination.

In travel control from the parking lot 170 at home to the destination, the vehicle 1 determines whether a cooperation route for traveling in the private land 160 between the parking lot 170 and the general road 150 is stored in the storage unit 120. In this example, no cooperation route is stored in the storage unit 120. Therefore, the vehicle 1 recommends to the user the memory processing of the private land section control in the travel control of the vehicle 1 to the current destination. It is assumed that the user approves the recommendation of the private land section control in response to this.

When the driving operation of the vehicle 1 by the user is started, the private land section memory that stores the route information on the leaving operation in the storage unit 120 is started. A section in which the private land section memory is performed is a section from the start of the leaving operation from the parking lot 170 until the vehicle 1 travels on a driveway (private road) 191 in the private land 160 and further travels from the driveway 191 to the general road 150, and is a private land section memory section 190 surrounded by a thick broken line in FIG. 10. The private land section memory section 190 includes the driveway 191 in the private land 160 and the general road region 159, which is a region of the general road 150. The user causes the vehicle 1 to travel on a travel route in the private land section memory section 190 by manual driving.

When the vehicle 1 leaves the private land section memory section 190 and travels to the general road 150, the travel control is performed by the general road assistance. A position where the general road assistance is started is a general road assistance start point 194, and a section in which the general road assistance is performed is a general road assistance section 195.

In this way, the vehicle 1 leaves the parking lot 170 at home, travels on the driveway 191, turns right from the driveway 191, and travels to the general road 150, as indicated by a movement route 192 indicated by a broken line. Then, information on the movement route 192 in the private land section memory section 190 is stored in the storage unit 120 together with the cooperation route #2 that cooperates with the travel route of the general road assistance control. At this time, in the private land section memory section 190, a road boundary 193 indicating a boundary of a region in which the vehicle 1 can travel by the private land section control is displayed. A position of the road boundary 193 is a position where the user temporarily stops the vehicle 1 before leaving the driveway 191 to the general road 150, and is configured to be set to any position by a user operation. The set road boundary 193 is stored in association with the movement route 192 and the cooperation route #2.

### (Fourth Operation Example)

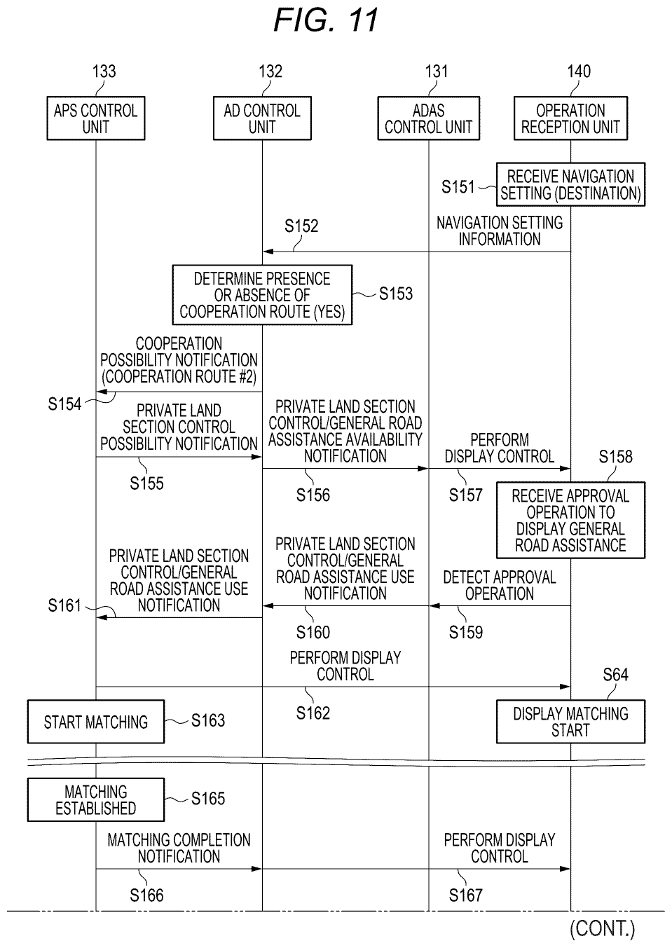

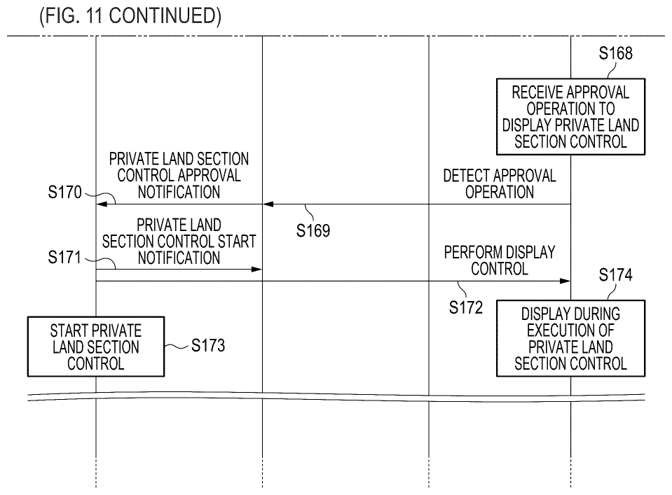

FIGS. 11 and 12 are sequence diagrams illustrating a fourth operation example of the vehicle 1. The fourth operation example is the same as the third operation example in that the fourth operation example is an operation example in a case where a user who gets on the vehicle 1 causes the vehicle 1 to leave a parking lot at home and goes out, but is different from the third operation example in that route information when the vehicle 1 is caused to leave the parking lot at home is stored in the storage unit 120 and the vehicle 1 can be caused to leave the parking lot at home by the private land section control.

In FIG. 11, processing of step S151 and step S152 is similar to processing of step S111 and step S112 in the third operation example in FIG. 8.

In travel control of the vehicle 1 from the home parking lot to the destination, the AD control unit 132 determines whether a route cooperating with a travel route of the general road assistance control is stored in the storage unit 120, that is, determines presence or absence of a cooperation route along which the vehicle 1 travels in a private land between the home parking lot and a general road (step S153). As described above, the cooperation route #2 when the vehicle 1 leaves the home parking lot is stored in the storage unit 120 in association with the route information on the leaving operation stored by the private land section memory and the road boundary information. Therefore, the determination of the presence or absence of the cooperation route is “YES”. The AD control unit 132 notifies the APS control unit 133 that there is a cooperation route, that is, the cooperation of the private land section control is likely to be possible (step S154). The stored cooperation route is, for example, the “cooperation route #2” stored in step S138 of the third operation example.

The APS control unit 133 notifies the AD control unit 132 that the travel control of the vehicle 1 by the private land section control is possible (step S155).

The AD control unit 132 notifies the ADAS control unit 131 that the travel control of the private land section control and the travel control of the general road assistance after the private land section control are available (step S156).

The ADAS control unit 131 performs display control on the operation reception unit 140 to display on the navigation HMI 62 that the travel control by the general road assistance is available in the travel control of the vehicle 1 to the current destination (step S157).

The operation reception unit 140 displays on the navigation HMI 62 that the travel control by the general road assistance is available (step S158). It is assumed that the user approves the use of the general road assistance control in response to this display. The operation reception unit 140 receives an approval operation from the user on the navigation HMI 62 (step S158). The operation reception unit 140 outputs, to the ADAS control unit 131, an operation detection signal notifying that the approval operation from the user is detected (step S159).

When receiving the operation detection signal from the operation reception unit 140, the ADAS control unit 131 notifies the AD control unit 132 that the travel control of the private land section control and the travel control of the general road assistance after the private land section control are to be used (step S160).

The AD control unit 132 notifies the APS control unit 133 that the travel control of the private land section control and the travel control of the general road assistance after the private land section control are to be used (step S161).

When receiving a private land section control/general road assistance use notification from the AD control unit 132, the APS control unit 133 performs the display control on the operation reception unit 140 to display, on the navigation HMI 62, a screen for notifying the user of the start of matching (step S162). Then, the APS control unit 133 starts processing of the matching (step S163).

The operation reception unit 140 displays, on the navigation HMI 62, a matching start, which is a screen display for notifying that the matching is started (step S164). For example, the operation reception unit 140 displays “Start matching for private land section control.” on the navigation HMI 62. The purpose of the private land section control is to perform control to cause the vehicle 1 to leave the parking lot 170 at home.

Then, when the matching is established (step S165), the APS control unit 133 notifies the AD control unit 132 that the matching is completed (step S166). The matching is established when a degree of matching between the current external environment information obtained by the external environment recognition unit 110 and, for example, the route information on the leaving operation associated with the cooperation route #2 is equal to or greater than a threshold.

The AD control unit 132 performs the display control on the operation reception unit 140 to display on the navigation HMI 62 that the matching is completed and the private land section control is possible in leaving control of the vehicle 1 from the parking lot because the matching is completed (step S167). The AD control unit 132 performs the display control on the operation reception unit 140 to prompt the user to perform an approval operation of the control transition such that the travel control of the vehicle 1 transitions from the general road assistance control to the private land section control. The display control of the navigation HMI 62 prompting the approval operation of the control transition is an example of the “first notification”of the present disclosure.

In order to notify the user, the operation reception unit 140 displays on the navigation HMI 62 that the matching is completed and the private land section control is possible (step S168). It is assumed that the user approves the use of the private land section control in response to this notification. The operation reception unit 140 receives an approval operation from the user on the navigation HMI 62 (step S168). The operation reception unit 140 outputs, to the AD control unit 132, an operation detection signal notifying that the approval operation from the user is detected (step S169).

The AD control unit 132 notifies the APS control unit 133 that the user approves the use of the private land section control, based on the operation detection signal from the operation reception unit 140 (step S170).

The APS control unit 133 notifies the AD control unit 132 that the travel control of the vehicle 1 by the private land section control is started (step S171). The APS control unit 133 performs the display control on the operation reception unit 140 to display on the navigation HMI 62 that the vehicle 1 is caused to travel by the private land section control (step S172). Then, the APS control unit 133 starts the private land section control of the vehicle 1 (step S173).

In step S167 described above, since the user approves the use of the private land section control, the APS control unit 133 starts the private land section control, but the present disclosure is not limited thereto. For example, when the user does not approve the use of the private land section control, the APS control unit 133 does not start the private land section control because no private land section control approval notification is issued.

The operation reception unit 140 displays, on the navigation HMI 62, a screen during execution of the private land section control for notifying that the vehicle 1 is traveling by the private land section control (step S174).

Then, in FIG. 12, the APS control unit 133 detects that the vehicle 1 reaches a road boundary by the travel control of the private land section control (step S175). The road boundary is, for example, the position of the road boundary set by the user in the third operation example described above. The APS control unit 133 performs control to temporarily stop the vehicle 1 at the road boundary (step S176). The APS control unit 133 notifies the AD control unit 132 that the vehicle 1 reaches the road boundary (step S177).

When receiving a road boundary reaching notification from the APS control unit 133, the AD control unit 132 notifies the APS control unit 133 that the travel control of the general road assistance is started for the vehicle 1 (step S178). The AD control unit 132 performs the display control on the operation reception unit 140 to display on the navigation HMI 62 that the general road assistance for the vehicle 1 is started (step S179). Then, the AD control unit 132 starts the general road assistance (step S180).

The APS control unit 133 receives a general road assistance start notification from the AD control unit 132 and ends the private land section control (step S181).

The operation reception unit 140 displays, on the navigation HMI 62, a screen during execution of the general road assistance for notifying that the vehicle 1 is traveling by the general road assistance control (step S182).

When the vehicle 1 travels to the destination by the general road assistance control, the AD control unit 132 detects reaching the destination (step S183). When the vehicle 1 reaches the destination, the AD control unit 132 ends the general road assistance (step S184).

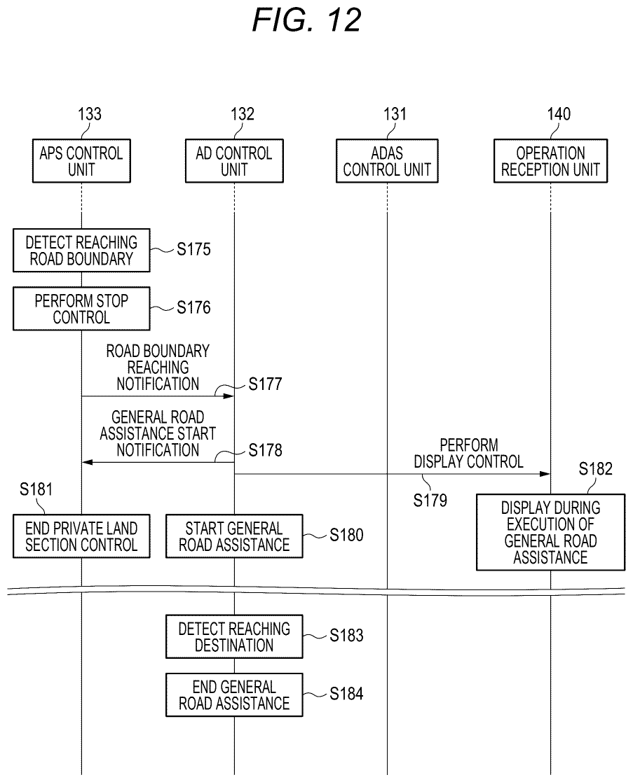

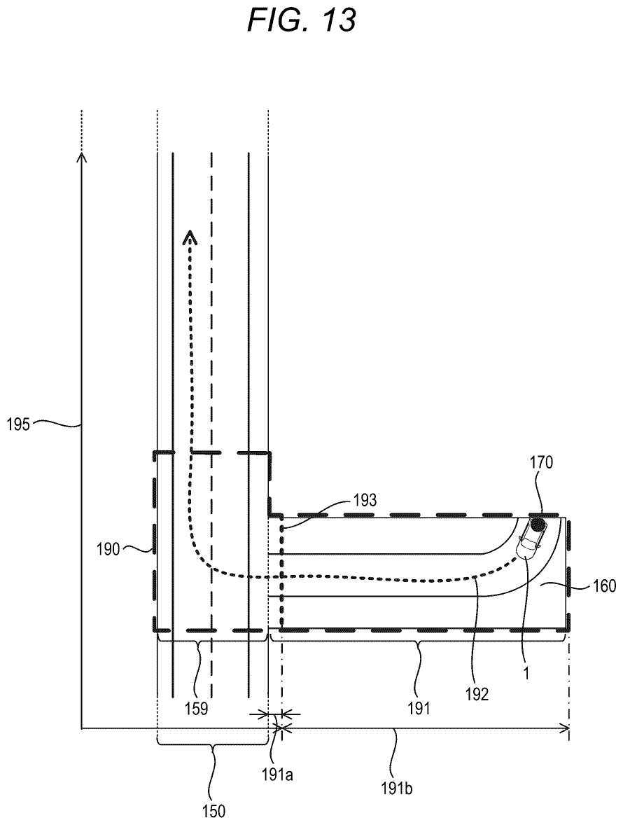

FIG. 13 is a diagram illustrating a next example of the state in which the vehicle 1 on which the user gets travels with the parking lot 170 at home as an operation start position. The next example is a travel example in a situation in which the route information when the vehicle 1 leaves the parking lot 170 at home is stored, as described in the fourth operation example of FIGS. 11 and 12. FIG. 13 illustrates a situation in which a destination of the vehicle 1 is set in the navigation device 60 to make the vehicle 1 toward the destination.

In travel control from the parking lot 170 at home to the destination, the vehicle 1 determines whether a cooperation route for traveling in the private land 160 between the parking lot 170 and the general road 150 is stored in the storage unit 120. As described in the third operation example described above, it is assumed that the cooperation route #2 is stored in the storage unit 120.

The vehicle 1 starts determination of success or failure of matching between the current external environment information obtained by the external environment recognition unit 110 and the route information on the leaving operation associated with the cooperation route #2. When the matching is established, the vehicle 1 obtains the approval of the user to perform the private land section control, and starts the private land section control based on the route information on the leaving operation associated with the cooperation route #2.

In FIG. 13, as the movement route 192 in the private land section memory section 190 surrounded by a thick broken line, the movement route 192 in the private land section memory section 190 stored in the storage unit 120 in the initial example (see FIG. 10) is applied. The private land section memory section 190 includes the driveway (private road) 191 in the private land 160 and the general road region 159 of the general road 150. In the private land section memory section 190, the road boundary 193 indicating a boundary of a region in which the vehicle 1 can travel by the private land section control is set. In the private land section memory section 190, a region to which the private land section control of the vehicle 1 is applied is a set private road region 191b of a section from the parking lot 170 to the road boundary 193. An excluded private road region 191a on a general road region 159 side with respect to the road boundary 193 is not subject to the private land section control even if the excluded private road region 191a is within a region of the driveway 191.

The vehicle 1 is controlled to travel by the private land section control in the set private road region 191b from the parking lot 170 to the road boundary 193, and is controlled to travel by the general road assistance when the vehicle 1 travels to the excluded private road region 191a beyond the road boundary 193. The set private road region 191b is a travelable area where the vehicle 1 can travel by the private land section control. The travelable area is an area set by the user setting the road boundary 193. The section in which the general road assistance is performed is the general road assistance section 195.

From the above, according to the control device 100, even in a case where the vehicle 1 is caused to leave the parking lot at home and the travel control is performed to the destination as in the third operation example and the fourth operation example, it is possible to achieve the same effect as in a case of the travel control in which the vehicle 1 is caused to enter the parking lot at home from the destination in the first operation example and the second operation example described above.

### Example of Use of Private Land Section Control

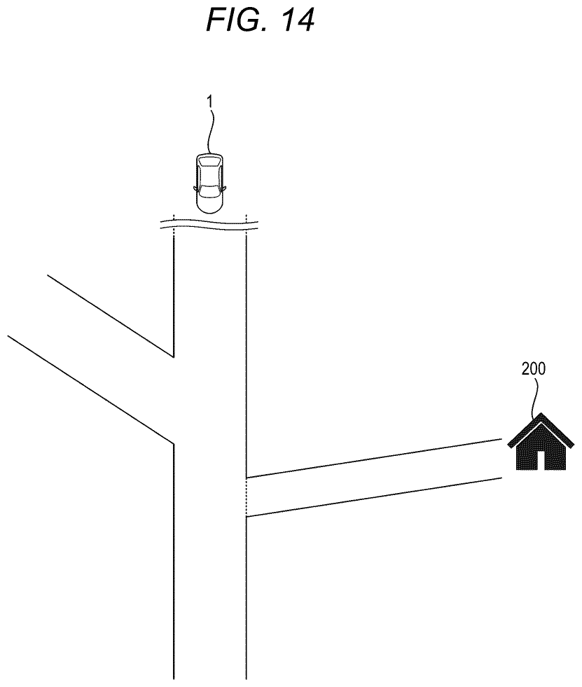

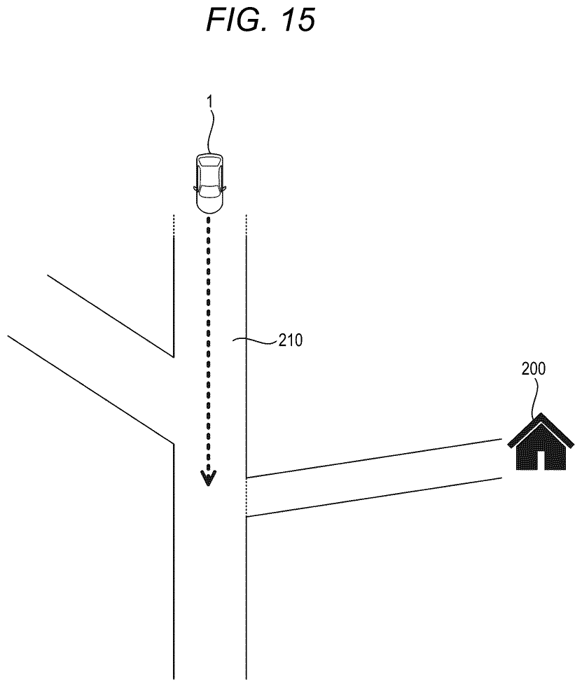

The private land section control used when a user in the vehicle 1 returns home from a destination will be described with reference to FIGS. 14 to 19. FIG. 14 is a diagram illustrating a state in which the user gets on the vehicle 1 and starts an engine at the destination. The user first sets a home 200 as a target position in the navigation device 60. FIG. 15 is a diagram illustrating a state in which the vehicle 1 is traveling on a general road 210 by the general road assistance control. The vehicle 1 is traveling on the general road 210 along a route indicated by an arrow A, for example, by the travel control of the general road assistance.

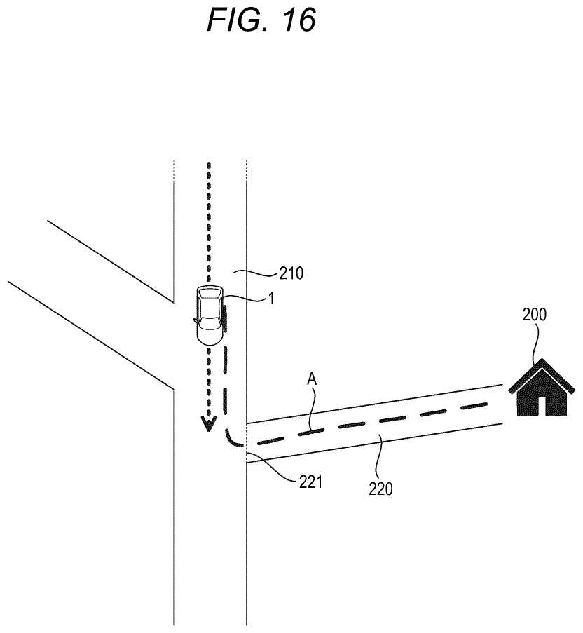

FIG. 16 is a diagram illustrating the start of the private land section memory of the vehicle 1. In a case where no cooperation route during past traveling is stored in the storage unit 120, when a travel position of the vehicle 1 reaches, for example, a determination area where a remaining distance to the home 200 is 88 m or less and an override operation by the user is started, the vehicle 1 stores route information on the override operation by the private land section memory.

For example, in FIG. 16, information on a movement route A of the vehicle 1 indicated by a broken line is stored by the private land section memory. The information on the movement route A includes information on a travel route of the override operation on the general road 210 and information on a travel route of the override operation on a driveway 220 extending to the home 200 continuously from the general road 210. The information on the movement route A includes information on a road boundary 221 indicating a boundary of the driveway 220. A region of the driveway 220 is a region of the movement route A on a home 200 side with respect to the road boundary 221. The information on the movement route A includes information on a travel route on which the vehicle turns left on the general road 210 and enters the driveway 220.

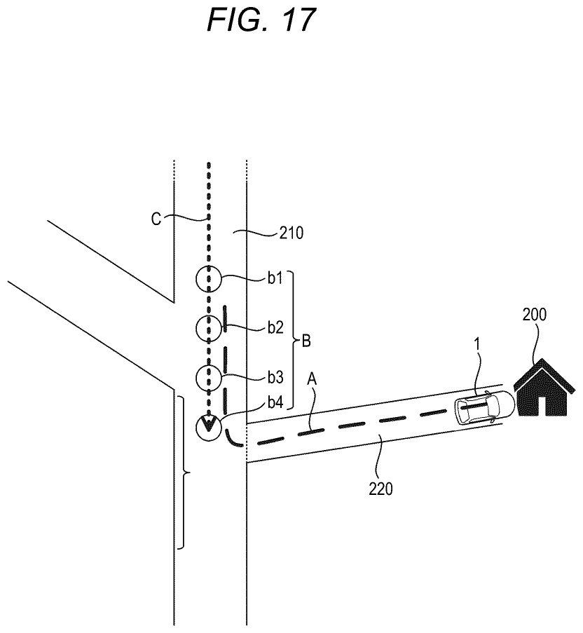

FIG. 17 is a diagram illustrating a state in which the vehicle 1 reaches the home 200, which is the target position. When the vehicle 1 reaches the home 200, in addition to the information on the movement route A stored by the private land section memory in FIG. 16, information on a cooperation route in a travel route from the destination to the home 200 is further stored by the private land section memory.

For example, information on a cooperation route B indicated by circles b1 to b4 in FIG. 17 is stored by the private land section memory. The cooperation route B is stored by the private land section memory as route information that cooperates with a travel route C of the general road assistance control on the general road 210. Accordingly, when the travel control of the vehicle 1 transitions from the general road assistance control to the private land section control in the travel route from the destination to the home 200, information indicating that the vehicle 1 transitions to the movement route A while traveling on the general road 210 toward the circle b1->b2->b3->b4 along the cooperation route B is stored by the private land section memory.

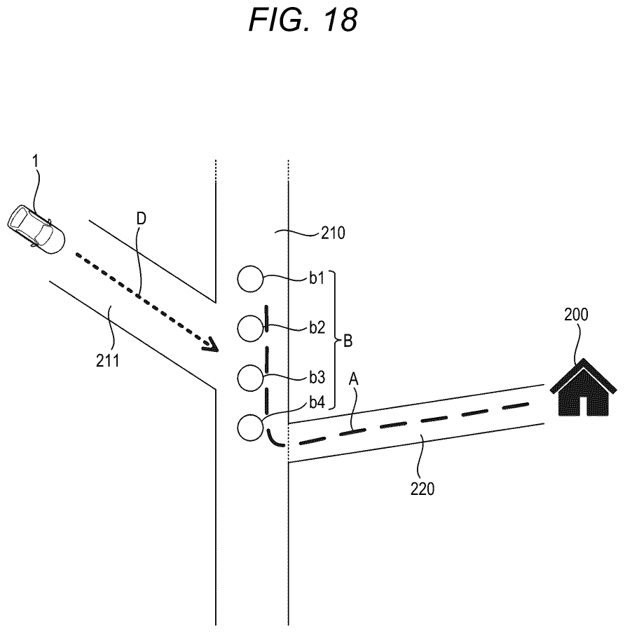

FIG. 18 is a diagram illustrating a state of the vehicle 1 returning to the home 200 along a travel route D different from the travel route C in FIG. 17. In FIG. 18, the travel control of the vehicle 1 by the general road assistance is performed on the travel route D indicated by a broken line of a general road 211. The travel route D is a route different from the travel route C (see FIG. 17) of the general road 210 with which the cooperation route B cooperates. Therefore, the cooperation route B that cooperates with the travel route C of the general road assistance control on the general road 210 is not applied to the vehicle 1 that travels on the travel route D of the general road 211 by the general road assistance control. It is determined that there is no cooperation route on the travel route D on which the general road assistance control is performed on the vehicle 1 on the general road 211.

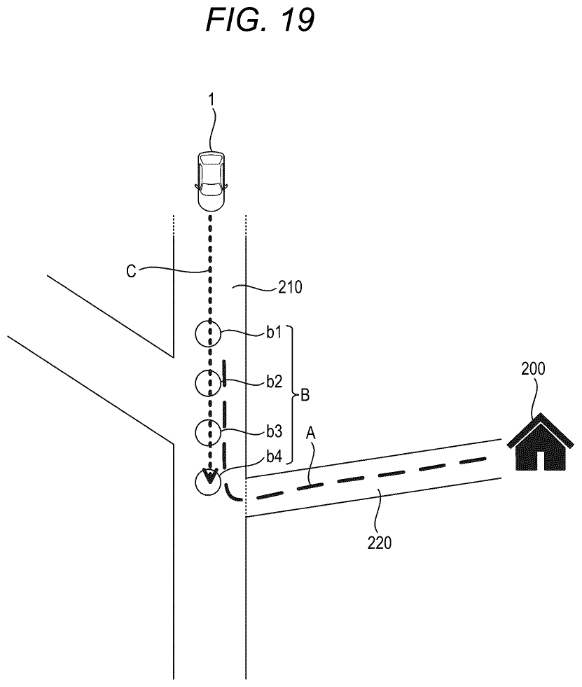

FIG. 19 is a diagram illustrating a state of the vehicle 1 returning to the home 200 along the same travel route as the travel route C in FIG. 17. In FIG. 19, the travel control of the vehicle 1 by the general road assistance is performed on the travel route C indicated by a broken line of the general road 210. The travel route C is the same route as the travel route C of the general road 210 with which the cooperation route B stored by the private land section memory in FIG. 17 cooperates. Therefore, the vehicle 1 reads the information on the movement route A stored by the private land section memory in association with the cooperation route B and performs matching. When the matching is established, the vehicle 1 transitions from the general road assistance control to the private land section control, and causes the vehicle 1 to travel to the home 200 based on the information on the movement route A and current external environment information.

In FIGS. 14 to 19 described above, a case where the vehicle 1 travels from a destination to a home has been described, but the present disclosure is not limited thereto. For example, it is possible to transition travel control in a similar manner when traveling from home to a destination.

The control method described in the above embodiment may be implemented by a computer executing a control program prepared in advance. The control program is stored in a computer-readable storage medium and executed by being read from the storage medium. In addition, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

Although the embodiment of the present disclosure has been described above, the present disclosure is not limited to the above embodiment, and modifications, improvements, and the like may be appropriately made.

For example, although an example in which the moving object is a vehicle has been described in the above embodiment, the present disclosure is not limited thereto. The idea of the present disclosure is not limited to the vehicle, and may also be applied to a robot, a ship, an aircraft, or the like that includes a drive source and that can be moved by power of the drive source.

In the present description, at least the following matters are described. Although corresponding constituent elements or the like in the embodiment described above are shown in parentheses, the present disclosure is not limited thereto.

(1) A vehicle control device including:
at least one processor (movement control unit 130 (ADAS control unit 131, AD control unit 132, APS control unit 133)) configured to perform travel control for moving a vehicle to a target position and to transition between a first travel mode (general road assistance control) and a second travel mode (private land section control), the vehicle including an external environment recognition unit (external environment recognition unit 110) configured to perform external environment recognition; and
a storage unit (storage unit 120) configured to store map information, in which
   the map information is map information on a region including a predetermined determination area and a travelable area where traveling in the second travel mode is possible, and
   the at least one processor is configured to
      determine, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition,
      transition, in response to determining that the travel condition is satisfied and the vehicle enters the travelable area, to the second travel mode, and
      cause the vehicle to travel in the second travel mode based on the map information stored in the storage unit and the external environment information obtained by the external environment recognition unit.

If the map information only includes, for example, the travelable area where the traveling in the second travel mode is possible, it is not possible to determine the success or failure of matching based on the map information and the external environment information unless the vehicle enters the travelable area. On the other hand, according to (1), since the map information on the region including the determination area for determining the travel condition in the second travel mode and the travelable area where the traveling in the second travel mode is possible is used, it is possible to determine the success or failure of matching before entering the travelable area. Therefore, it is possible to quickly determine the travel condition, and the mode transition between the first travel mode and the second travel mode can be smoothed.

(2) The vehicle control device according to (1), in which
the storage unit stores the map information based on the external environment information obtained by the external environment recognition unit.

According to (2), it is possible to accurately determine the travel condition in the second travel mode by determining the success or failure of matching using the map information based on the external environment information obtained by the external environment recognition unit, and the mode transition between the first travel mode and the second travel mode can be smoothed.

(3) The vehicle control device according to (2), in which
the storage unit stores the map information based on the external environment information obtained by the external environment recognition unit during past traveling of the vehicle.

According to (3), it is possible to more accurately determine the travel condition in the second travel mode by determining the success or failure of matching using the map information based on the external environment information obtained by the external environment recognition unit during the past traveling of the vehicle. Therefore, the mode transition between the first travel mode and the second travel mode can be smoothed.

(4) The vehicle control device according to any one of (1) to (3), in which
the travelable area in the region indicated by the map information is an area set by a user.

According to (4), since it is possible to determine, by the setting of the user, a range of the travelable area where the traveling is possible in the second travel mode, it is possible to set a position at which the transition is performed between the first travel mode and the second travel mode to an appropriate position according to a surrounding environment of a travel route.

(5) The vehicle control device according to any one of (1) to (4), in which
the at least one processor is configured to cause the vehicle to travel in the first travel mode until the vehicle enters the travelable area even when it is determined that the travel condition is satisfied.

According to (5), even when the travel condition in the second travel mode is satisfied, the vehicle is caused to travel in the first travel mode until the vehicle enters the area where the traveling is possible in the second travel mode, and thus it is possible to perform appropriate mode transition according to the surrounding environment of the travel route.

(6) The vehicle control device according to any one of (1) to (5), in which
the travel condition includes at least one of condition whether a state in which a travel speed of the vehicle in the determination area exceeds a first speed does not continue for a predetermined time or more, and condition whether the travel speed of the vehicle in the determination area does not exceed a second speed.

As in (6), as the travel condition for transition from the first travel mode to the second travel mode, it is necessary that the travel speed of the vehicle 1 satisfies a predetermined condition.

(7) A vehicle control method performed by a vehicle control device, the vehicle control device including at least one processor configured to perform travel control for moving a vehicle to a target position and to transition between a first travel mode and a second travel mode, the vehicle including an external environment recognition unit configured to perform external environment recognition and a storage unit configured to store map information that is map information on a region including a predetermined determination area and a travelable area where traveling in the second travel mode is possible, the vehicle control method including:
determining, by the at least one processor, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition;
transitioning, by the at least one processor, to the second travel mode in response to determining that the travel condition is satisfied and the vehicle enters the travelable area; and
causing, by the at least one processor, the vehicle to travel in the second travel mode based on the map information stored in the storage unit and the external environment information obtained by the external environment recognition unit.

If the map information only includes, for example, the travelable area where the traveling in the second travel mode is possible, it is not possible to determine the success or failure of matching based on the map information and the external environment information unless the vehicle enters the travelable area. On the other hand, according to (7), since the map information on the region including the determination area for determining the travel condition in the second travel mode and the travelable area where the traveling in the second travel mode is possible is used, it is possible to determine the success or failure of matching before entering the travelable area. Therefore, it is possible to quickly determine the travel condition, and the mode transition between the first travel mode and the second travel mode can be smoothed.

(8) A non-transitory computer-readable storage medium storing a control program for a vehicle control device, the vehicle control device including at least one processor configured to perform travel control for moving a vehicle to a target position and to transition between a first travel mode and a second travel mode, the vehicle including an external environment recognition unit configured to perform external environment recognition and a storage unit configured to store map information that is map information on a region including a predetermined determination area and a travelable area where traveling in the second travel mode is possible, the control program causing the at least one processor to execute processing including:
determining, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition;
transitioning to the second travel mode in response to determining that the travel condition is satisfied and the vehicle enters the travelable area; and
causing the vehicle to travel in the second travel mode based on the map information stored in the storage unit and the external environment information obtained by the external environment recognition unit.

If the map information only includes, for example, the travelable area where the traveling in the second travel mode is possible, it is not possible to determine the success or failure of matching based on the map information and the external environment information unless the vehicle enters the travelable area. On the other hand, according to (8), since the map information on the region including the determination area for determining the travel condition in the second travel mode and the travelable area where the traveling in the second travel mode is possible is used, it is possible to determine the success or failure of matching before entering the travelable area. Therefore, it is possible to quickly determine the travel condition, and the mode transition between the first travel mode and the second travel mode can be smoothed.

What is claimed is:

1. A vehicle control device comprising:
at least one processor configured to perform travel control for moving a vehicle to a target position and to transition between a first travel mode and a second travel mode, the vehicle including an external environment recognition unit configured to perform external environment recognition; and
a storage unit configured to store map information, wherein
the map information is map information on a region including a predetermined determination area and a travelable area where traveling in the second travel mode is possible, and
the at least one processor is configured to
determine, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition,
transition, in response to determining that the travel condition is satisfied and the vehicle enters the travelable area, to the second travel mode, and
cause the vehicle to travel in the second travel mode based on the map information stored in the storage unit and the external environment information obtained by the external environment recognition unit.

2. The vehicle control device according to claim 1, wherein
the storage unit stores the map information based on the external environment information obtained by the external environment recognition unit.

3. The vehicle control device according to claim 2, wherein
the storage unit stores the map information based on the external environment information obtained by the external environment recognition unit during past traveling of the vehicle.

4. The vehicle control device according to claim 1, wherein
the travelable area in the region indicated by the map information is an area set by a user.

5. The vehicle control device according to claim 1, wherein
the at least one processor is configured to cause the vehicle to travel in the first travel mode until the vehicle enters the travelable area even when it is determined that the travel condition is satisfied.

6. The vehicle control device according to claim 1, wherein
the travel condition includes at least one of condition whether a state in which a travel speed of the vehicle in the determination area exceeds a first speed does not continue for a predetermined time or more, and condition whether the travel speed of the vehicle in the determination area does not exceed a second speed.

7. A vehicle control method performed by a vehicle control device, the vehicle control device including at least one processor configured to perform travel control for moving a vehicle to a target position and to transition between a first travel mode and a second travel mode, the vehicle including an external environment recognition unit configured to perform external environment recognition and a storage unit configured to store map information that is map information on a region including a predetermined determination area and a travelable area where traveling in the second travel mode is possible, the vehicle control method comprising:
determining, by the at least one processor, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition;
transitioning, by the at least one processor, to the second travel mode in response to determining that the travel condition is satisfied and the vehicle enters the travelable area; and
causing, by the at least one processor, the vehicle to travel in the second travel mode based on the map information stored in the storage unit and the external environment information obtained by the external environment recognition unit.

8. A non-transitory computer-readable storage medium storing a control program for a vehicle control device, the vehicle control device including at least one processor configured to perform travel control for moving a vehicle to a target position and to transition between a first travel mode and a second travel mode, the vehicle including an external environment recognition unit configured to perform external environment recognition and a storage unit configured to store map information that is map information on a region including a predetermined determination area and a travelable area where traveling in the second travel mode is possible, the control program causing the at least one processor to execute processing comprising:
determining, in response to the vehicle entering the determination area while the vehicle is traveling in the first travel mode, a travel condition in the second travel mode, the travel condition including whether external environment information obtained by the external environment recognition unit and the map information stored in the storage unit satisfy a predetermined matching condition;
transitioning to the second travel mode in response to determining that the travel condition is satisfied and the vehicle enters the travelable area; and
causing the vehicle to travel in the second travel mode based on the map information stored in the storage unit and the external environment information obtained by the external environment recognition unit.
